(19) United States
(12) Patent Application Publication
(10) Pub. No.: US 2026/0106838 A1
(43) Pub. Date: Apr. 16, 2026

(54) Error Handling and Dynamic Path Maximum Transmission Unit Discovery in Communication Networks

(71) Applicant: Cisco Technology, Inc., San Jose, CA (US)

(72) Inventors: Jaganbabu Rajamanickam, KANATA (CA); Madhan Sankaranarayanan, CHENNAI (IN); Darren R. Dukes, KANATA (CA); David Toscano, KANATA (CA); Radu Teodor Valceanu, KANATA (CA)

(21) Appl. No.: 18/917,957

(22) Filed: Oct. 16, 2024

(51) Int. Cl. H04L 47/36; H04L 43/0823; H04L 45/00; H04L 45/76

(52) U.S. Cl. CPC H04L 47/36; H04L 43/0847; H04L 45/20; H04L 45/34; H04L 45/76

(57) ABSTRACT

Devices and methods provide for error handling and dynamic path maximum transmission unit (MTU) discovery in a network with segment routing. In segment routing, applying traditional MTU Discovery may not be possible due to lack of tunnel identifiers. Therefore, when an ingress edge device (IED), in a segment routing domain, receives a first error packet including a first MTU value (MTU1) and an underlay encapsulation, the IED generates a second error packet based on the first error packet, determines a second MTU value (MTU2) based on MTU1 and the underlay encapsulation, updates the second error packet with MTU2, and relays the second error packet including MTU2 to a host device via an egress edge device (EED). The IED receives the second error packet, including a segment identifier of the IED, returned by the EED, based on which the IED identifies a segment routing policy for updating MTU2.

The present disclosure relates to communication networks. More particularly, the present disclosure relates to error handling and dynamic path maximum transmission unit discovery in a communication network with segment routing.

### BACKGROUND

Path Maximum Transmission Unit (MTU) discovery (PMTUD) may provide a method for intelligently discovering an MTU for a network path to allow packets to be delivered without fragmentation. In networking, the MTU may provide a measurement indicating the largest packet that a network device can accept. Internet Protocol version 4 (IPv4) may allow fragmentation and thus may include a “Don't Fragment” flag in an Internet Protocol (IP) header of a packet. PMTUD in IPv4 may operate by transmitting test packets along a network path with the “Don't Fragment” flag turned on. If any network device (for example, a router) along the network path drops the packet, the network device may transmit an Internet Control Message Protocol (ICMP) error packet with its MTU to a source node. The source node may lower the MTU and transmit another test packet. This process may be repeated until the test packets are small enough to traverse the entire network path without being dropped.

Unlike in IPv4, in Internet Protocol version 6 (IPv6), packet fragmentation may occur only at source nodes. In IPv6, intermediate nodes between a source node and a destination node may not be permitted to fragment packets. If a packet needs to be fragmented due to a smaller MTU along the network path, a source node may fragment the original packet into smaller packets before transmission, ensuring the packets do not require fragmentation along the network path to the destination node. These smaller packets may then be reassembled at a destination node. By placing the responsibility for fragmentation on the endpoints rather than the intermediate nodes, IPv6 may reduce the overhead on the intermediate nodes and improve network performance.

Conventional IP networks may rely on complex protocols for traffic engineering and management, which may be simplified by a source-routing paradigm, namely, segment routing, which may use a single set of instructions to dictate the path traffic takes through the network, thereby reducing the complexity associated with managing multiple protocols. Segment routing may allow for a packet to follow a predefined path, defined by a list of segments, inside a segment routing domain. Segment Routing over an IPv6 data plane (SRv6) and IPv6 can be leveraged together by implementing an IPv6 and SRv6 header in an IPv6 packet. Further, as opposed to some tunneling techniques, SRv6 may leverage IPv6 addresses as segment identifiers (SIDs) to encode segment routing information directly, thereby eliminating the need for separate tunnel identifiers.

When a source node transmits packets via an overlay network, a network node in an underlay network may fail to forward an encapsulated packet due to its size exceeding the MTU of the intermediate node. In this example scenario, the corresponding underlay network node may generate an error packet corresponding to an ICMP PTB error. The underlay network node may be required to relay the error packet back to the source node in the overlay network or execute some other corrective action such as reducing the MTU of a tunnel on which the error occurred.

Conventional PMTUD methods typically use a source address or a tunnel identifier for identifying an offending physical interface or the tunnel on which the error occurred and updating its MTU. However, since SRv6 does not utilize a tunnel identifier in its segment routing header (SRH), applying the conventional PMTUD methods to determine a dynamic path MTU for an SRv6 encapsulation is not possible. Therefore, there is no context for relaying the error packet corresponding to the ICMP-PTB error back to the source node. Further, in an SRv6 architecture, as there is no source address associated with a segment routing policy or a segment identifier and there is no explicit tunnel identifier, there is difficulty in identifying an offending segment routing policy or segment identifier, and accordingly a Virtual Routing and Forwarding (VRF) table of an ingress node to which to apply the MTU.

### SUMMARY OF THE DISCLOSURE

Devices and methods for error handling and dynamic path maximum transmission unit (MTU) discovery in a network with segment routing in accordance with embodiments of the disclosure are described herein. In many embodiments, a network device for error handling and dynamic path MTU discovery in a network with segment routing may include a processor, a network interface controller configured to provide access to a network, and a memory communicatively coupled to the processor, wherein the memory may include an error handling logic that may be configured to receive a first error packet including a first MTU value and an underlay encapsulation. The error handling logic may further be configured to generate a second error packet based on the first error packet, determine a second MTU value based on the first MTU value and the underlay encapsulation, update the second error packet with the second MTU value, and relay the second error packet including the second MTU value to a host device via an egress edge device.

In a number of embodiments, the network device may be configured as an ingress edge device communicatively coupled to the host device and to the egress edge device via one or more intermediate devices.

In a variety of embodiments, the error handling logic may further be configured to determine that the first error packet corresponding to a Packet-Too-Big (PTB) error is received in a segment routing domain of the network, wherein the second error packet is relayed to the host device via the egress edge device in response to determining that the first error packet is received in the segment routing domain.

In various embodiments, the second error packet may include an inner header including a source address field and a destination address field, and an outer header including a source address field and a destination address field.

In more embodiments, the error handling logic may further be configured to set a time-to-live (TTL) value of each of the inner header and the outer header of the second error packet to a default TTL value.

In additional embodiments, to relay the second error packet to the host device via the egress edge device, the error handling logic may further be configured to: swap data of the source address field and the destination address field in the inner header of the second error packet, and include a segment identifier of the egress edge device as a destination in the destination address field of the outer header of the second error packet.

In further embodiments, the segment identifier may be a Virtual Private Network-Segment Identifier.

In still more embodiments, to relay the second error packet to the host device via the egress edge device, the error handling logic may further be configured to: transmit, to the egress edge device, the second error packet including the segment identifier of the egress edge device; receive, from the egress edge device, the second error packet in which the outer header is replaced by another outer header including a segment identifier of the network device; remove the other outer header from the second error packet; and transmit the second error packet to the host device.

In still further embodiments, the segment identifier of the network device may be associated with a Virtual Routing and Forwarding (VRF) table corresponding to an address of the host device.

In still additional embodiments, the error handling logic may further be configured to transmit the second error packet to the host device based on the VRF table associated with the segment identifier of the network device.

In some more embodiments, determining the second MTU value may include decrementing a length of the underlay encapsulation from the first MTU value.

In yet various embodiments, a network device for error handling and dynamic path MTU discovery in a network with segment routing may include a processor, a network interface controller configured to provide access to a network, and a memory communicatively coupled to the processor, wherein the memory may include an error handling logic that may be configured to receive a first error packet corresponding to a PTB error. The error handling logic may further be configured to: generate a second error packet based on the first error packet, wherein the second error packet may include a resultant MTU value; transmit the generated second error packet to an egress edge device; receive the second error packet, including a segment identifier of the network device, returned by the egress edge device; identify, based on the segment identifier of the network device, a segment routing policy associated with a host device; and update the resultant MTU value in the segment routing policy.

In yet more embodiments, the generated second error packet may further include an extension object configured to indicate a requirement for a segment routing policy update for the resultant MTU value.

In still yet more embodiments, the error handling logic may further be configured to identify the segment routing policy associated with the host device and update the resultant MTU value in the segment routing policy, in response to the received second error packet including the extension object.

In many further embodiments, the first error packet may include an initial MTU value and an underlay encapsulation, wherein the error handling logic may further be configured to determine the resultant MTU value by decrementing a length of the underlay encapsulation from the initial MTU value.

In many additional embodiments, the second error packet may further include an outer header, wherein prior to transmitting the generated second error packet to the egress edge device, the error handling logic may further be configured to set a TTL value of the outer header to a default TTL value.

In still yet further embodiments, the second error packet may further include an inner header, wherein prior to transmitting the generated second error packet to the egress edge device, the error handling logic may further be configured to determine and update a TTL value of the inner header of the generated second error packet based on a segment identifier END behavior associated with the second error packet.

In still yet additional embodiments, the determined TTL value may be configured to expire at the network device upon receiving the second error packet returned by the egress edge device.

In several embodiments, the second error packet may further include an inner header including a destination address, wherein to identify the segment routing policy associated with the host device, the error handling logic may further be configured to: identify a VRF table associated with the segment identifier of the network device; and perform a lookup on the destination address in the identified VRF table, wherein the segment routing policy is identified as a result of the lookup.

In several more embodiments, a method for error handling and dynamic path MTU discovery in a network with segment routing may include: receiving a first error packet comprising a first MTU value and an underlay encapsulation, generating a second error packet based on the first error packet, determining a second MTU value based on the first MTU value and the underlay encapsulation, updating the second error packet with the second MTU value, and relaying the second error packet including the second MTU value to a host device via an egress edge device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a network system including a plurality of devices implemented in a segment routing domain of a network in accordance with various embodiments of the disclosure;

FIG. 2 is a schematic flow diagram for relaying an error packet including a resultant maximum transmission unit (MTU) value to a host device via an egress edge device in accordance with various embodiments of the disclosure;

FIG. 3 is a schematic flow diagram for identifying a segment routing policy associated with a host device and updating a resultant MTU value in the segment routing policy in accordance with various embodiments of the disclosure;

FIG. 4 is a flowchart depicting a process for relaying an error packet including a resultant MTU value to a host device via an egress edge device in accordance with various embodiments of the disclosure;

FIG. 5 is a flowchart depicting a process for relaying an error packet including a resultant MTU value to a host device in accordance with various embodiments of the disclosure;

FIG. 6 is a flowchart depicting a process for generating an error packet including a resultant MTU value in accordance with various embodiments of the disclosure;

FIG. 7 is a flowchart depicting a process for relaying an error packet including a resultant MTU value to a host device via an egress edge device in accordance with various embodiments of the disclosure;

FIG. 8 is a flowchart depicting a process for identifying a segment routing policy associated with a host device and updating a resultant MTU value in the segment routing policy in accordance with various embodiments of the disclosure;

FIG. 9 is a flowchart depicting a process for identifying a segment routing policy associated with a host device and updating a resultant MTU value in the segment routing policy in accordance with various embodiments of the disclosure;

FIG. 10 is a flowchart depicting a process for generating an error packet including a resultant MTU value in accordance with various embodiments of the disclosure; and

FIG. 11 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, devices and methods are discussed herein that handle errors and perform dynamic path Maximum Transmission Unit (MTU) discovery in a network with segment routing. The devices and methods discussed herein provide a context for relaying an error packet corresponding to a Packet-Too-Big (PTB) error back to a source node, for example, a host device. In many embodiments, the devices and methods discussed herein may relay the error packet corresponding to the PTB error from a core network, for example, a Segment Routing over an Internet Protocol version 6 (IPv6) data plane (SRv6) core network, to a host device by updating a relevant SRv6 encapsulation overhead to the original MTU set in the error packet, which is usually challenging due to lack of tunnel identifiers in segment routing. An SRv6 core network may refer to a network architecture that leverages SRv6 to streamline and enhance network operations. In SRv6, encapsulation overhead may refer to the additional bytes added to a packet header to support SRv6 operations.

In a number of embodiments, the devices and methods discussed herein may identify the affected segment routing policy and/or the segment identifier on which the error occurred, on a headend of the network and update their MTU. The segment routing policy may refer to an ordered list of segments. In segment routing, Segment Identifiers (SIDs) are utilized to encode routing instructions or segments that define the network path a packet should take. Examples of the routing instructions may include “forward packet according to the shortest path to destination”, or “forward packet through a specific interface”, or “deliver the packet to a given application/service instance”, or the like. The headend may correspond to a main network device or an edge device that handles the entry and processing of traffic into a network segment. For example, in segment routing, a headend router or device may refer to an initial point where the segment routing policy is applied and routing instructions are inserted into packets. This headend router may be responsible for managing and forwarding packets according to segment routing policies. The headend of the segment routing policy may steer packets onto the segment routing policy.

In a variety of embodiments, the list of segments of a segment routing policy can be specified explicitly in SRv6 as an ordered list of SRv6 SIDs. An SRv6 SID may refer to an IPv6 address explicitly associated with a segment. The segment routing policy can be configured by an operator, provisioned via a Network Configuration (NETCONF) protocol, or provisioned via a Path Computation Element Protocol (PCEP). The segment routing policy can be utilized for traffic engineering (TE), Operations, Administration, and Maintenance (OAM), or Fast Reroute (FRR) purposes. In various embodiments, in an SRv6 architecture, the devices and method discussed herein identify an offending physical interface or a tunnel on which an error occurs, and update the MTU for an SRv6 encapsulation, without relying on a source address or a tunnel identifier in a Segment Routing Header (SRH). Further, in more embodiments, the devices and methods discussed herein may identify specific segment routing policies or segment identifiers, for example, Virtual Private Network-Segment Identifiers (VPN-SIDs), that are affected by Packet-Too-Big (PTB) errors without relying on a source address or a tunnel identifier. For example, the devices and method discussed herein identify an offending segment routing policy or a VPN-SID and accordingly a Virtual Routing and Forwarding (VRF) table of an ingress node to which to apply the MTU, without relying on a source address associated with the segment routing policy or the VPN-SID, and an explicit tunnel identifier.

A conventional method utilized for restricting the MTU for SRv6 traffic includes statically configuring the MTU for SRv6 traffic. This static SRv6 MTU configuration may include manually setting and managing the MTU for SRv6 networks to ensure that packets are transmitted without fragmentation. However, in this method, if one segment routing policy, for example, one SRv6 policy, has a lower MTU, the configuration may affect other segment routing policies that may allow a higher MTU. The devices and methods discussed herein provide a more flexible, dynamic method where the MTU change is applied only to the affected segment routing policies and/or VPN-SIDs.

When a source node transmits packets via an overlay network, a network node in a corresponding underlay network may fail to forward an encapsulated packet due to its size exceeding the MTU of the network node. In this example scenario, assuming an IPv6 underlay, a corresponding underlay node may generate an error packet corresponding to an Internet Control Message Protocol (ICMP)-PTB error. The underlay node in the underlay network may be required to relay the error packet to the source node in the overlay network or execute some other corrective action such as reducing the MTU of a tunnel on which the error occurred. The devices and methods discussed herein may relay the error packet received from the SRv6 underlay nodes to the source node, with an underlay overhead updated to include the MTU value received from the SRv6 underlay nodes. In additional embodiments, the devices and methods discussed herein may correlate the error packet and update the MTU of the segment routing policy on a local underlay headend, for example, an ingress edge node, based on the VPN-SID of the ingress edge node.

The devices and methods discussed herein provide an error handling logic configured to relay a resultant error packet including a resultant MTU value to a host device via an egress edge device. In further embodiments, the error handling logic may be executed by a network device configured as an ingress edge device. The ingress edge device may be communicatively coupled to the host device and to the egress edge device via one or more intermediate devices. The host device may initiate transmission of a packet to a destination device. The ingress edge device may receive and encapsulate the transmitted packet. The ingress edge device may then proceed to transmit the encapsulated packet along a network path including intermediate devices and the egress edge device to the destination device. One of the intermediate devices may fail to forward the encapsulated packet due to its size exceeding a link MTU of the intermediate device. In this case, the intermediate device may generate and transmit a first error packet corresponding to a PTB error, for example, an ICMP-PTB error, to the ingress edge device. In various embodiments, the ingress edge device may receive the first error packet corresponding to the PTB error. The first error packet may include a first MTU value (also referred to as “initial MTU value”) and an underlay encapsulation. Underlay encapsulation in networking may refer to the methods and technologies utilized to encapsulate and transport network traffic within an underlying physical or virtual network infrastructure. Encapsulation may include adding headers and, in various embodiments, trailers containing information needed for routing and delivery to the first error packet. The underlay encapsulation may introduce an additional overhead to the first error packet or any other packet transmitted between the ingress edge device and the egress edge device. The additional overhead introduced by the underlay encapsulation may refer to the added bytes in the packet header of the first error packet.

In yet various embodiments, the ingress edge device may generate a second error packet based on the first error packet. The second error packet may include an inner header including a source address field and a destination address field, an outer header including a source address field and a destination address field, and an error datagram. In more embodiments, the ingress edge device may set a time-to-live (TTL) value of each of the inner header and the outer header of the second error packet to a default TTL value. In some more embodiments, to relay the second error packet to the host device via the egress edge device, the ingress edge device may swap data of the source address field and the destination address field in the inner header of the second error packet and include a segment identifier of the egress edge device as a destination in the destination address field of the outer header of the second error packet. The segment identifier is, for example, a VPN-SID.

In yet further various embodiments, the ingress edge device may determine a second MTU value based on the first MTU value and the underlay encapsulation. In still further embodiments, the ingress edge device may determine the second MTU value by decrementing a length of the underlay encapsulation from the first MTU value. In additional embodiments, the ingress edge device may update the second error packet with the second MTU value and relay the second error packet including the second MTU value to the host device via the egress edge device. For example, the second MTU value may be updated in the inner header of the second error packet. In still additional embodiments, the ingress edge device may determine that the first error packet corresponding to the PTB error is received in a segment routing domain of the network, and relay the second error packet to the host device via the egress edge device in response to determining that the first error packet is received in the segment routing domain.

In yet more embodiments, to relay the second error packet to the host device via the egress edge device, the ingress edge device may transmit, to the egress edge device, the second error packet including the segment identifier of the egress edge device and receive, from the egress edge device, the second error packet in which the outer header is replaced by another outer header (e.g., a new outer header) including a segment identifier of the ingress edge device. In still yet more embodiments, the segment identifier of the ingress edge device is associated with a VRF table corresponding to an address of the host device. The address of the host device may be indicated as a destination address in the inner header of the returned second error packet. The ingress edge device may then remove the other outer header from the second error packet and transmit the second error packet to the host device. In many further embodiments, the ingress edge device may transmit the second error packet to the host device based on the VRF associated with the segment identifier of the ingress edge device.

In many additional embodiments, the devices and methods discussed herein provide an error handling logic configured to identify a segment routing policy associated with a host device and update a resultant MTU value (also referred to as the second MTU value) in the segment routing policy. To enable the update of the resultant MTU value in the segment routing policy, the ingress edge device may execute one or more additional operations while generating the second error packet and before forwarding the returned second error pack to the host device. For example, in a variety of embodiments, prior to transmitting the generated second error packet to the egress edge device, the ingress edge device may determine and update a TTL value of the inner header of the generated second error packet based on a segment identifier END behavior associated with the second error packet. In various embodiments, the determined TTL value may be configured to expire at the ingress edge device upon receiving the second error packet returned by the egress edge device. In numerous embodiments, the ingress edge device may be configured to append an extension object to the generated second error packet. The extension object may be configured to indicate a requirement for a segment routing policy update for the resultant MTU value. In numerous additional embodiments, the ingress edge device may identify the segment routing policy associated with the host device and update the resultant MTU value in the segment routing policy, in response to the returned second error packet including the extension object. In additional embodiments, to identify the segment routing policy associated with the host device, the ingress edge device may identify a VRF table associated with the segment identifier of the network device and perform a lookup on a destination address, included in the inner header of the returned second error packet, on the identified VRF table. The segment routing policy may be identified as a result of the lookup. The destination address may be an IP address of the host device.

In further embodiments, the devices and methods discussed herein may execute performance measurement to detect liveliness of a segment routing policy in SRv6. Performance measurement may be utilized for monitoring network metrics for links and end-to-end traffic engineering label switched paths. Performance measurement may measure various link characteristics including, for example, packet loss, delay, delay variation, bandwidth utilization, or the like. In still more embodiments, the devices and methods discussed herein may reuse performance measurement to detect a path MTU, instead of running both a path MTU discovery protocol and performance measurement separately. The devices and methods discussed herein may leverage performance measurement for both path liveliness detection and path MTU discovery. For example, test probes utilized for performance measurement can be generated with varying MTUs, thus, inspecting path MTU and performance simultaneously. In still further embodiments, the devices and methods discussed herein may use performance measurement to discover the path MTU on top of its liveliness and/or network-delay detection functionality by integrating the above solution with the performance measurement. The network-delay detection functionality may correspond to identifying and quantifying time of data travel from a source node to a destination node across a network. In still additional embodiments, one of the metrics for network-delay detection may be latency defined, for example, by propagation delay, transmission delay, processing delay, and queueing delay.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

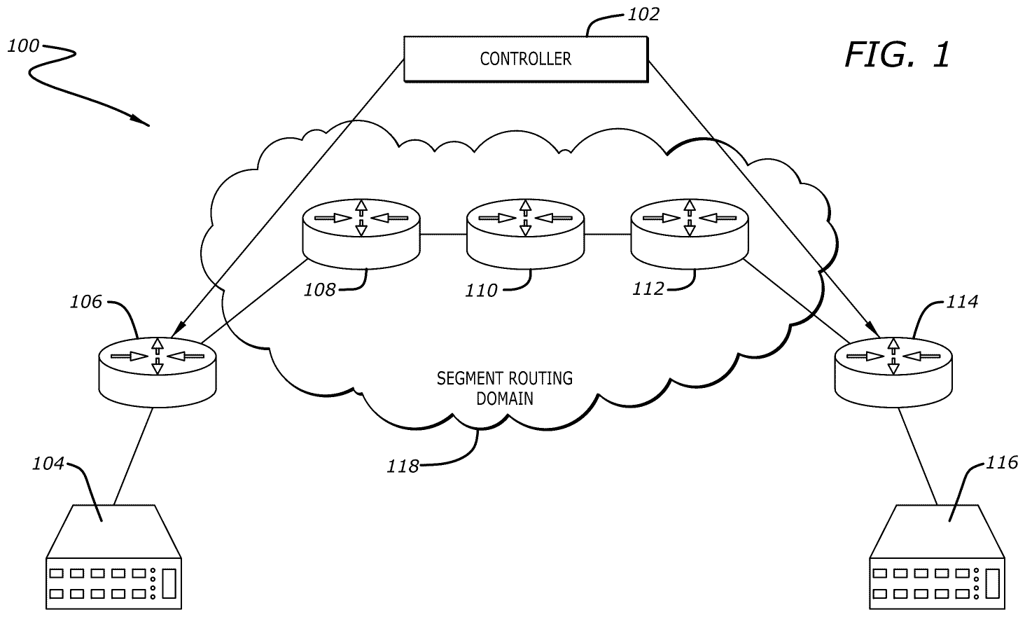

Referring to FIG. 1, a schematic block diagram of a network system 100 including a plurality of devices implemented in a segment routing domain 118 of a network in accordance with various embodiments of the disclosure is shown. The plurality of devices may include, for example, edge routers, transit routers, segment routing-enabled switches, or the like. In many embodiments, the segment routing domain 118 may refer to a collection of nodes or network devices 106, 108, 110, 112, and 114 (referred to as “network devices 106-114”) configured to participate in segment routing protocols. These network devices 106-114 may be connected to the same physical infrastructure (for example, a service provider's network). In a number of embodiments, the network devices 106-114 may be remotely connected to each other, for example, in an enterprise Virtual Private Network (VPN) or an overlay. Within the segment routing domain 118, a network device can execute ingress, transit, or egress procedures.

In a variety of embodiments, each of the network devices 106-114 may steer a packet through an ordered list of instructions called segments. A segment can represent any instruction that is topological or service-based. A segment can have a semantic local to a network device (e.g., any of the network devices 106-114), or a semantic global within the segment routing domain 118. Segment routing may provide a mechanism that allows a flow to be restricted to a specific topological path, while maintaining a per-flow state only at an ingress node(s), for example, the network device 106, to the segment routing domain 118. In various embodiments, segment routing can be applied to an Internet Protocol (IP) architecture, for example, an IP version 6 (IPv6) architecture, with a new type of routing header. In this example, the ordered list of segments may be encoded as an ordered list of IPv6 addresses in the routing header.

In the network system 100 shown in FIG. 1, in yet various embodiments, a source device 104 and a destination device 116 can reside outside the segment routing domain 118, while a network path between the source device 104 and the destination device 116 can traverse through the segment routing domain 118. In an example, the source device 104 and the destination device 116 may be customer edge devices such as customer edge routers that are part of a customer's network and may interact with the segment routing domain 118 of a service provider. The source device 104 and the destination device 116 may each be identified by a Media Access Control (MAC) address and/or an Internet Protocol (IP) address. The source device 104 and the destination device 116 may be, for example, host devices, routers, switches, or the like. The source device 104 and the destination device 116 may transmit and/or receive data within the network. In more embodiments, the source device 104 may connect to one or more network devices, for example, the network device 106 (interchangeably, referred to as “ingress edge device 106”) of the network. Similarly, in additional embodiments, the destination device 116 may connect to one or more network devices, for example, the network device 114 (interchangeably, referred to as “egress edge device 114”), of the network.

In still additional embodiments, the source device 104 and the destination device 116 may perform initial segment identification and apply specific segment routing policies for entry and exit of traffic into and from the customer's network, respectively. In further embodiments, the network path between the source device 104 and the destination device 116 may include an ordered list of network segments that connect the ingress edge device 106 to the egress edge device 114 via one or more intermediate devices 108, 110, and 112. The ingress edge device 106 and the egress edge device 114 may be located at the edge of the segment routing domain 118 as shown in FIG. 1. In still further embodiments, the source device 104 and the destination device 116 that are outside the segment routing domain 118 may be operably coupled to the ingress edge device 106 and the egress edge device 114, respectively.

In several embodiments, the ingress edge device 106 and the egress edge device 114 may be provider edge devices including, for example, edge routers, switches, or the like. In still more embodiments, the ingress edge device 106 and the egress edge device 114 may be configured to inject and remove segment identifiers (SIDs) from packets, respectively. The ingress edge device 106 and the egress edge device 114 may handle entry and exit points of traffic into and out of the segment routing domain 118, respectively. The ingress edge device 106 and the egress edge device 114 may connect the customers' network to the service provider's network and may apply segment routing policies to incoming and outgoing traffic, respectively. The ingress edge device 106 and the egress edge device 114 may manage how customer traffic is segmented and routed through the service provider's network.

In yet additional embodiments, the intermediate network devices 108, 110, and 112 may be deployed in the network path between the ingress edge device 106 and the egress edge device 114. The intermediate network devices 108, 110, and 112 may be provider devices, for example, provider routers, switches, or the like. In yet more embodiments, the network system 100 may further include a controller 102 operably and communicatively coupled to the ingress edge device 106 and the egress edge device 114. The controller 102 may be utilized to manage and program the segment routing policies. The controller 102 may assist in optimizing and automating the network by adjusting segment routing policies based on, for example, real-time network conditions. The controller 102 may also be utilized to support bandwidth computation and resource reservation for determining a global optimal path or a network forwarding path. In a centralized scenario, the controller 102 may be configured to allocate and instantiate segments. While FIG. 1 shows a single controller 102 operably coupled to the ingress edge device 106 and the egress edge device 114, the segment routing architecture does not restrict the number of controllers. In still yet more embodiments, multiple controllers may program the same segment routing domain 118. The segment routing architecture may allow these controllers to determine which SIDs are instantiated at which network devices and which sets of local Segment Routing Label Block (SRLB) and global Segment Routing Global Block (SRGB) labels are available at which network device.

In Multi-Protocol Label Switching (MPLS) networks, all intermediate network devices between an ingress edge device and an egress edge device may support MPLS forwarding. When a packet cannot be forwarded due to the size of the packet exceeding a link Maximum Transmission Unit (MTU), the MPLS forwarding node may generate an error packet corresponding to a Packet-Too-Big (PTB) error, for example, an Internet Control Message Protocol (ICMP)-PTB error, for an inner Internet Protocol packet such as an IP version 4 (IPv4) or IP version 6 (IPv6) packet, and push the offending packets label stack onto the error packet. This ensures the egress edge device forwards the ICMP-PTB error back to a source device in a Layer 3 (L3) Virtual Private Network (VPN) overlay behind the ingress edge device. However, this method may not work in a Segment Routing over an IPv6 data plane (SRv6) network since not all nodes support SRv6 forwarding and are aware of the SRv6 encapsulation. SRv6 encapsulation may refer to encapsulating a packet with an outer IPv6 header and an optional Segment Routing Header (SRH). The SRH may be inserted between an IPv6 header and a payload of the packet.

SRv6 encapsulation allows the transport of native IPv4 and IPv6 data across an SRv6-enabled network. For example, referring to FIG. 1, the source device 104 may transmit native IPv4and IPv6 data to the ingress edge device 106 (for example, an ingress SRv6 router). The ingress edge device 106 may encapsulate and forward the IPv4 and IPv6 data via an SRv6 tunnel. The SRv6 tunnel may transport the encapsulated data across the SRv6-enabled network to the egress edge device 114 (for example, an egress SRv6 router). The egress edge device 114 may decapsulate and forward the data as native IPv4 and IPv6 data. The ingress edge device 106 may encapsulate the SRv6-tunneled data using an IPv6 header, where the destination address is a unique SRv6 segment identifier (SID), and is processed and forwarded in the IPv6 data plane.

An SRv6 encapsulation overhead includes the space required for the SRH. The SRH may include a segment list containing Segment Identifiers (SIDs) and other fields for routing and processing instructions. Each SID in the segment list may represent a specific segment in the segment routing domain 118. This SRv6 encapsulation overhead may relate to how SRv6 encodes segment routing instructions and manages packet forwarding. In an example scenario, the SRH itself may have a fixed size of 8 bytes, but the total size of the SRH increases with the number of SIDs. Each SID may add 16 bytes to the SRH. The segment list, which holds the SIDs, can contribute directly to the overhead. For example, if a packet uses four SIDs, the SRH can include an additional 64 bytes, that is, 16 bytes per SID. Combining the IPv6 header and the SRH overhead, the total encapsulation overhead for a packet with four SIDs would be 40 (IPv6)+8 (base SRH)+64 (SIDs)=112 bytes. In numerous embodiments, the ingress edge device 106 may relay the error packet corresponding to the ICMP-PTB error from a core network, for example, an SRv6 core network, to the source device 104 via the egress edge device 114 by updating a relevant SRv6 encapsulation overhead to the original MTU set in the error packet.

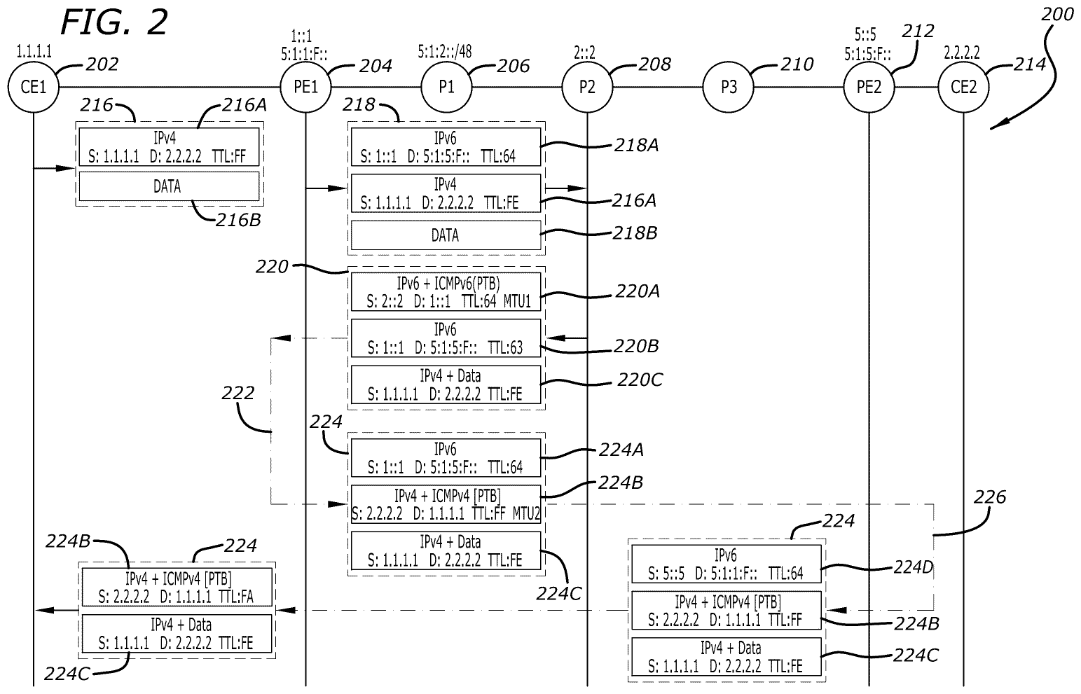

Although a specific embodiment for a network system 100 including a plurality of devices implemented in a segment routing domain of a network suitable for carrying out the various steps, processes, methods, and operations described herein is discussed with respect to FIG. 1, any of a variety of systems and/or processes may be utilized in accordance with embodiments of the disclosure. For example, in addition to supporting segment routing based on an IPv6 forwarding plane, the devices and methods discussed herein may support segment routing based on an MPLS forwarding plane. The elements depicted in FIG. 1 may also be interchangeable with other elements of FIG. 2-11 as required to realize a particularly desired embodiment.

Referring to FIG. 2, a schematic flow diagram 200 for relaying an error packet including a resultant MTU value to a host device via an egress edge device in accordance with various embodiments of the disclosure is shown. The flow diagram 200 in FIG. 2 illustrates a method for relaying an error packet corresponding to a PTB error received from underlay nodes, for example, SRv6 underlay nodes, to the host device, for example, a customer edge device, with an underlay overhead updated to include a received MTU value. The embodiments illustrated in FIG. 2 are described in the context of a network system including customer edge devices CE1 202 and CE2 214, provider edge devices PE1 204 and PE2 212, and intermediate provider devices P1 206, P2 208, and P3 210 as a non-limiting example. In this example, CE1 202 may be a host device, PE1 204 may be an ingress edge device such as an ingress edge router, PE2 212 may be an egress edge device such as an egress edge router, and CE2 214 may be a destination device. In many embodiments, the devices PE1 204, P1 206, P2 208, P3 210, and PE2 212 may represent a collection of nodes in a segment routing domain.

In an example scenario shown in FIG. 2, IP addresses of CE1 202, PE1 204, PE2 212, and CE2 214 may be 1.1.1.1, 1::1, 5::5, and 2.2.2.2, respectively. Further, the VPN-SIDs of PE1 204 and PE2 212 may be 5:1:1:F:: and 5:1:5 F::, respectively. Hereinafter, CE1 202 may be interchangeably referred to as “host device CE1 202”, PE1 204 may be interchangeably referred to as “ingress edge device PE1 204”, PE2 212 may be interchangeably referred to as “egress edge device PE2 212”, and CE2 214 may be interchangeably referred to as “destination device CE2 214”.

In a non-limiting example, it is assumed that the host device CE1 202 initiates transmission of a packet, for example, an IPv4 packet 216, to the destination device CE2 214. The IPv4 packet 216 may include an IPv4 header 216A and a payload 216B. The payload 216B may include the actual data to be transmitted to the destination device CE2 214. The IPv4 header 216A may include, for example, the IP address (e.g., 1.1.1.1) of the host device CE1 202 as a source address; the IP address (e.g., 2.2.2.2) of the destination device CE2 214 as a destination address, and a Time-To-Live (TTL) value of FF, where FF is a hexadecimal representation of the TTL value equivalent to 255 in decimal. In a number of embodiments, the ingress edge device PE1 204 may receive the IPv4 packet 216 and decrement the TTL value in the IPv4 header 216A from FF to FE. Further, to transmit the IPv4 packet 216 across an SRv6 network which combines segment routing with IPv6, the ingress edge device PE1 204 may be configured to encapsulate the IPv4 packet 216, for example, by performing an IPv4-in-IPv6 encapsulation and obtain an encapsulated IPv6 packet 218. To encapsulate the IPv4 packet 216, the ingress edge device PE1 204 may add an IPv6 header 218A and embed the original IPv4 packet 216 inside a payload of the IPv6 packet 218. Depending on a size of the payload of the IPv6 packet 218, the ingress edge device PE1 204 may be configured to embed the IPv4 header 216A and at least a portion of the payload 216B (represented as Data 218B) in the payload of the IPv6 packet 218. In the context of the IPv6 packet 218, the IPv6 header 218A may correspond to an outer header and the IPv4 header 216A may correspond to an inner header of the IPv6 packet 218. The IPv6 header 218A may include, for example, the IP address (e.g., 1::1) of the ingress edge device PE1 204 as a source address, a VPN-SID (e.g., 5:1:5:F::) of the egress edge device PE2 212 as a destination address, and a TTL value of 64. The ingress edge device PE1 204 may then proceed to transmit the IPv6 packet 218 along the network path including the intermediate devices P1 206, P2 208, P3 210, and the egress edge device PE2 212 to the destination device CE2 214.

Consider an example scenario where the intermediate device P2 208 may fail to forward the encapsulated IPv6 packet 218 due to its size exceeding a link MTU of the intermediate device P2 208. In this example scenario, assuming an IPv6 underlay, the intermediate device P2 208 may generate and transmit a first error packet 220 corresponding to a PTB error, for example, an ICMP-PTB error, to the ingress edge device PE1 204. In an example, the first error packet 220 may correspond to an ICMPv6-PTB error and may be referred to as an ICMPv6-PTB error packet. The first error packet 220 may include an IPv6+ICMPv6-PTB header 220A and an error datagram (e.g., a payload) including at least a portion of the encapsulated IPv6 packet 218. For example, the error datagram in the first error packet 220 may include an IPv6 header 220B corresponding to the IPv6 header 218A and IPv4+Data 220C corresponding to the payload of the IPv6 packet 218. The IPv6+ICMPv6-PTB header 220A may include, for example, the IP address (e.g., 2::2) of the intermediate device P2 208 as a source address, the IP address (e.g., 1::1) of the ingress edge device PE1 204 as a destination address, and a TTL value of 64. Further, the TTL value in the IPv6 header 220B may have been decremented by 1, at the intermediate device P1 206, to read as 63. In various embodiments, the first error packet 220 may further include a first MTU value (denoted as “MTU1” in FIG. 2) and an underlay encapsulation. In more embodiments, the intermediate device P2 208 may include the first MTU value in the IPv6+ICMPv6-PTB header 220A of the first error packet 220. The first MTU value may correspond to the link MTU of the intermediate device P2 208. In yet various embodiments, the underlay encapsulation may be an SRv6 encapsulation including an IPv6 header (e.g., the IPv6 header 220B), an SRH, and a payload.

In numerous embodiments, the ingress edge device PE1 204 may be configured to receive the first error packet 220 corresponding to the PTB error. In response to receiving the first error packet 220, the ingress edge device PE1 204 may be configured to generate a second error packet 224. The second error packet 224 may include an outer header 224A, an inner header 224B, and an error datagram 224C. In additional embodiments, the outer header 224A and the inner header 224B may be IP headers. Generation of the second error packet 224 is indicated by an arrow 222 in FIG. 2.

To generate the second error packet 224, the ingress edge device PE1 204 may be configured to generate the outer header 224A and the inner header 224B, and append the error datagram 224C to the generated headers 224A and 224B. To generate the headers 224A and 224B, the ingress edge device PE1 204 may be configured to extract the error datagram from the first error packet 220. Further, the ingress edge device PE1 204 may be configured to utilize one or more headers (e.g., the IPv6 header 220B and the IPv4 header in the IPv4+Data 220C) and their extensions in the extracted error datagram to generate the outer header 224A and the inner header 224B. Header extensions may include additional headers (e.g., authentication headers, routing headers, security headers, etc.) that can be added to basic IPv6 or IPv4 headers to provide more functionality. In an example, the ingress edge device PE1 204 may generate the outer header 224A similar to the IPv6 header 220B of the extracted error datagram of the first error packet 220, with the same source address of 1::1, the same destination address of 5:1:5:F::, and a TTL value set to a default value of 64. Further, the ingress edge device PE1 204 may generate the inner header 224B by swapping the source address and the destination address of the IPv4 header in the IPv4+Data 220C of the extracted error datagram. Swapping the source address and the destination address of the IPv4 header, in the IPv4+Data 220C, to generate the inner header 224B ensures that the second error packet 224 may travel to the egress edge device PE2 212 and be forwarded to the host device CE1 202 that is behind the ingress edge device PE1 204. The inner header 224B of the second error packet 224, therefore, may include the IP address (e.g., 2.2.2.2) of the destination device CE2 214 as a source address, the IP address (e.g., 1.1.1.1) of the host device CE1 202 as a destination address, and a TTL value set to the default value of FF. In some more embodiments, if the extracted datagram from the first error packet 220 includes an IPv4 header as an inner header (e.g., in the IPv4+Data 220C), the ingress edge device PE1 204 may generate the second error packet 224 as an ICMPv4-PTB message. For example, as shown in FIG. 2, the inner header 224B corresponds to ICMPv4-PTB message. In still additional embodiments, the error datagram 224C of the second error packet 224 may correspond to the IPv4+Data 220C of the error datagram extracted from the first error packet 220.

In still more embodiments, the ingress edge device PE1 204 may determine a second MTU value (denoted as MTU2 in FIG. 2) based on the first MTU value and the underlay encapsulation. To determine the second MTU value, the ingress edge device PE1 204 may decrement a length of the underlay encapsulation from the first MTU value. For example, the ingress edge device PE1 204 may determine the second MTU value using the following equation (1):

$$[ MTU 2 ] = [ Received\_MTU1 ] - [ Extracted Error - Datagram - Outer - Header - Length ] \qquad ( 1 )$$

where, the extracted Error-Datagram-Outer-IP-Header-Length includes the IPv6 header 220B and its extensions.

In other words, from the link MTU of the intermediate device P2 208 (e.g., the first MTU value), the ingress edge device PE1 204 may subtract the additional overhead due to the underlay encapsulation and obtain the second MTU value. In an example, the link MTU may be 1500 bytes and the underlay encapsulation may be 40 bytes. In this example, the ingress edge device PE1 204 may determine the second MTU value for the second error packet 224 as (1500−40)=1460 bytes instead of 1500 bytes. The ingress edge device PE1 204 may be further configured to update the second error packet 224 with the second MTU value. For example, the ingress edge device PE1 204 may update the inner header 224B of the second error packet 224 to include the second MTU value (denoted as “MTU2” in FIG. 2). As shown in FIG. 2, the ingress edge device PE1 204 may include the second MTU value, MTU2, in the ICMP-PTB message, for example, the ICMPv4-PTB message, of the second error packet 224. Thus, the ingress edge device PE1 204 may relay the second MTU value in the second error packet 224, which may account for the overhead of the underlay encapsulation. In yet more embodiments, the ingress edge device PE1 204 may be further configured to remove the outer header 220B from the error datagram of the first error packet 220 and append the resulting error datagram 224C to the headers 224A and 224B and obtain the second error packet 224.

When the ingress edge device PE1 204 receives the first error packet 220, the ingress edge device PE1 204 may be unaware about a Virtual Routing and Forwarding (VRF) table with which the IP address, for example, 1.1.1.1, of the host device CE1 202 is associated. However, the IPv6 header 220B of the error datagram of the first error packet 220 may include the VPN-SID allocated to the egress edge device PE2 212, which may be associated with the correct VRF table associated with the IP address of the host device CE1 202. Thus, in order to identify the correct VRF table associated with the IP address of the host device CE1 202 for relaying the second error packet 224 to the host device CE1 202, the ingress edge device PE1 204 may generate the second error packet 224 with the VPN-SID of the egress edge device PE2 212 indicated as the destination address in the outer header 224A and the IP address of the host device CE1 202 indicated as the destination address in the inner header 224B. Accordingly, in many additional embodiments, the ingress edge device PE1 204 may transmit the generated second error packet 224 towards its destination, that is, towards the egress edge device PE2 212. For example, the ingress edge device PE1 204 may transmit the generated second error packet 224 towards the egress edge device PE2 212 based on the VPN-SID of the egress edge device PE2 212 indicated in the destination address field of the outer header 224A.

Upon receiving the second error packet 224, the egress edge device PE2 212 may be configured to perform a lookup in a VRF table, corresponding to the VPN-SID of the egress edge device PE2 212, for the destination address, for example, 1.1.1.1, indicated in the inner header 224B of the second error packet 224. This lookup may result in the VPN-SID of the ingress edge device PE1 204 that is being utilized for SRv6 encapsulation. The egress edge device PE2 212 may further determine that the destination address, for example, 1.1.1.1, indicated in the inner header 224B of the second error packet 224 is reachable via the ingress edge device PE1 204. Thus, the egress edge device PE2 212 may replace the outer header 224A of the second error packet 224 with another outer header 224D. Replacement of the outer header 224A with the other outer header 224D is indicated by an arrow 226 in FIG. 2. The other header 224D may include the IP address (e.g., 5::5) of the egress edge device PE2 212 as the source address, the VPN-SID (e.g., 5:1:1:F::) of the ingress edge device PE1 204 as the destination address, in the other outer header 224D of the second error packet 224. The egress edge device PE2 212 may then transmit the second error packet 224 in which the outer header 224A is replaced with the other outer header 224D towards its destination, that is, the ingress edge device 204. As a result, when the ingress edge device PE1 204 receives the returned second error packet 224, the ingress edge device PE1 204 can now determine how to route the second error packet 224 utilizing the correct VRF table. In still yet additional embodiments, the ingress edge device PE1 204 may remove the new outer header 224D from the second error packet 224 and transmit the resultant second error packet 224 with the header 224B and the error datagram 224C to the host device CE1 202. In other words, the ingress edge device PE1 204 relays the second error packet 224 including the second MTU value (e.g., the resultant MTU value) to the host device CE1 202 via the egress edge device 214.

Although a specific embodiment for relaying an error packet including a resultant maximum transmission unit (MTU) value to a host device via an egress edge device suitable for carrying out the various steps, processes, methods, and operations described herein is discussed with respect to FIG. 2, any of a variety of systems and/or processes may be utilized in accordance with embodiments of the disclosure. For example, if an inner header of the error datagram of the first error packet is an IPv6 header, the ingress edge device may generate an ICMPv6-PTB message for inclusion in the second error packet, instead of an ICMPv4-PTB message as shown in FIG. 2. The elements depicted in FIG. 2 may also be interchangeable with other elements of FIG. 1 and FIG. 3-11 as required to realize a particularly desired embodiment.

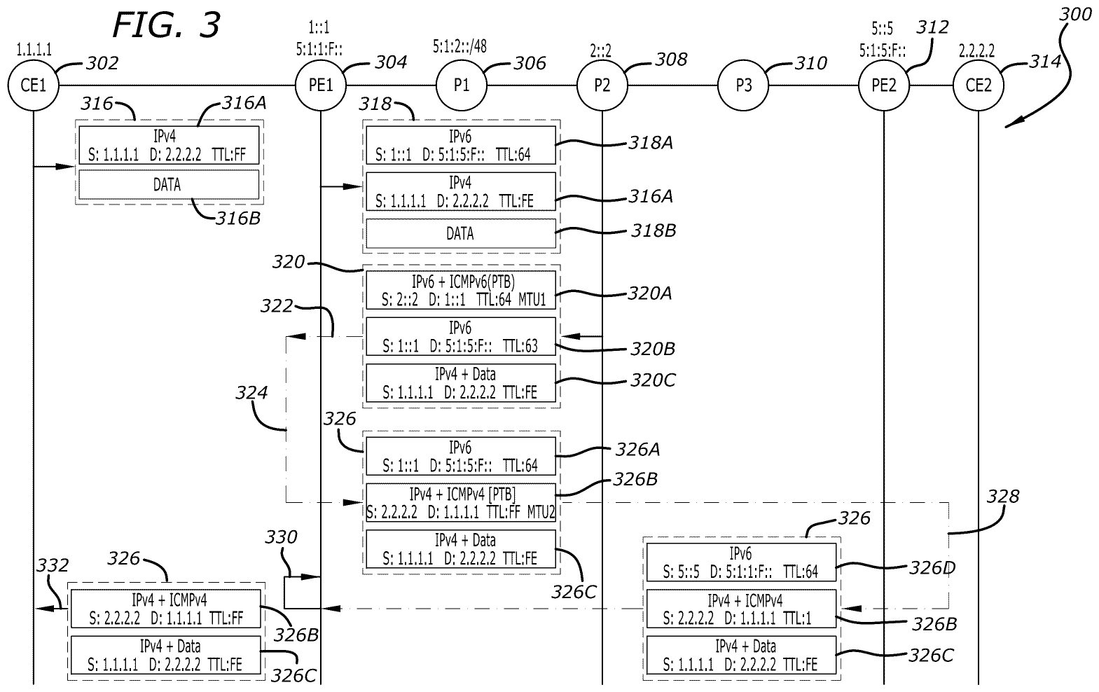

Referring to FIG. 3, a schematic flow diagram 300 for identifying a segment routing policy associated with a host device and updating a resultant MTU value in the segment routing policy in accordance with various embodiments of the disclosure is shown. The flow diagram 300 in FIG. 3 illustrates a method for correlating an error packet corresponding to a PTB error received from underlay nodes, for example, SRv6 underlay nodes, and updating an MTU value associated with the local segment routing policy and/or VPN-SIDs. The embodiments illustrated in FIG. 3 are described in the context of a network system including customer edge devices CE1 302 and CE2 314, provider edge devices PE1 304 and PE2 312, and intermediate provider devices P1 306, P2 308, and P3 310 as a non-limiting example. In this example, CE1 302 may be a host device, PE1 304 may be an ingress edge device such as an ingress edge router, and PE2 312 may be an egress edge device such as an egress edge router. In many embodiments, the devices PE1 304, P1 306, P2 308, P3 310, and PE2 312 may represent a collection of nodes in a segment routing domain. In a number of embodiments, the hop-limit propagation may not be enabled on the provider edge devices PE1 304 and PE2 312. Hop-limit propagation may refer to a mechanism by which a hop-limit or TTL of a packet is managed as the packet travels through a network. The hop-limit field is decremented by each network device that processes the packet to prevent indefinite looping and to ensure proper delivery.

In an example scenario shown in FIG. 3, IP addresses of CE1 302, PE1 304, PE2 312, and CE2 314 may be 1.1.1.1, 1::1, 5::5, and 2.2.2.2, respectively. Further, the VPN-SIDs of PE1 304 and PE2 312 may be 5:1:1:F:: and 5:1:5:F::, respectively. Hereinafter, CE1 302 may be interchangeably referred to as “host device CE1 302”, PE1 304 may be interchangeably referred to as “ingress edge device PE1 304”, PE2 312 may be interchangeably referred to as “egress edge device PE2 312”, and CE2 314 may be interchangeably referred to as “destination device CE2 314”.

In a non-limiting example, it is assumed that the host device CE1 302 initiates transmission of a packet, for example, an IPv4 packet 316, to the destination device CE2 314. The IPv4 packet 316 may include an IPv4 header 316A and a payload 316B. The payload 316B may include the actual data to be transmitted to the destination device CE2 314. The IPv4 header 316A may include, for example, the IP address (e.g., 1.1.1.1) of the host device CE1 302 as a source address, the IP address (e.g., 2.2.2.2) of the destination device CE2 314 as a destination address, and a TTL value of FF, where FF is a hexadecimal representation of the TTL value equivalent to 255 in decimal. In various embodiments, the ingress edge device PE1 304 may receive the IPv4 packet 316 and decrement the TTL value in the IPv4 header 316A from FF to FE. Further, to transmit the IPv4 packet 316 across an SRv6 network which combines segment routing with IPv6, the ingress edge device PE1 304 may be configured to encapsulate the IPv4 packet 316, for example, by performing an IPv4-in-IPv6 encapsulation and obtain an encapsulated IPv6 packet 318. To encapsulate the IPv4 packet 316, the ingress edge device PE1 304 may add an IPv6 header 318A and embed the original IPv4 packet 316 inside a payload of the IPv6 packet 318. Depending on a size of the payload of the IPv6 packet 318, the ingress edge device PE1 304 may be configured to embed the IPv4 header 316A and at least a portion of the payload 316B (represented as Data 318B) in the payload of the IPv6 packet 318. In the context of the IPv6 packet 318, the IPv6 header 318A may correspond to an outer header and the IPv4 header 316A may correspond to an inner header of the IPv6 packet 318. The outer IPv6 header 318A may include, for example, the IP address (e.g., 1::1) of the ingress edge device PE1 304 as a source address, a VPN-SID (e.g., 5:1:5:F::) of the egress edge device PE2 312 as a destination address, and a TTL value of 64. The ingress edge device PE1 304 may then proceed to transmit the IPv6 packet 318 along the network path including the intermediate devices P1 306, P2 308, and P3 310, and the egress edge device PE2 312 to the destination device CE2 314.

Consider an example scenario where the intermediate device P2 308 may fail to forward the encapsulated IPv6 packet 318 due to its size exceeding a link MTU of the intermediate device P2 308. In this example scenario, assuming an IPv6 underlay, the intermediate device P2 308 may generate and transmit a first error packet 320 corresponding to a PTB error, for example, an ICMP-PTB error, to the ingress edge device PE1 304. In an example, the first error packet 320 may correspond to an ICMPv6-PTB error and may be referred to as an ICMPv6-PTB error packet. The first error packet 320 may include an IPv6+ICMPv6-PTB header 320A and an error datagram (e.g., a payload) including at least a portion of the encapsulated IPv6 packet 318. For example, the error datagram in the first error packet 320 may include an IPv6 header 320B corresponding to the IPv6 header 318A and IPv4+Data 320C corresponding to the payload of the IPv6 packet 318. The IPv6+ICMPv6-PTB header 320A may include, for example, the IP address (e.g., 2::2) of the intermediate device P2 308 as a source address, the IP address (e.g., 1::1) of the ingress edge device PE1 304 as a destination address, and a TTL value of 64. Further, the TTL value in the IPv6 header 320B may have been decremented by 1, at the intermediate device P1 306, to read as 63. In various embodiments, the first error packet 320 may further include a first MTU value (denoted as “MTU1” in FIG. 3) and an underlay encapsulation. In further embodiments, the intermediate device P2 308 may include the first MTU value in the IPv6+ICMPv6-PTB header 320A of the first error packet 320. The first MTU value may correspond to the link MTU of the intermediate device P2 308. In yet various embodiments, the underlay encapsulation may be an SRv6 encapsulation including an IPv6 header, an SRH, and a payload.

In numerous embodiments, the ingress edge device PE1 304 may be configured to receive the first error packet 320 corresponding to the PTB error. In response to receiving the first error packet 320, the ingress edge device PE1 304 may be configured to generate a second error packet 326. The second error packet 326 may include an outer header 326A, an inner header 326B, and an error datagram 326C. In additional embodiments, the outer header 326A and the inner header 326B may be IP headers. Generation of the second error packet 326 is indicated by an arrow 322 in FIG. 3.

To generate the second error packet 326, the ingress edge device PE1 304 may be configured to generate the outer header 326A and the inner header 326B, and append the error datagram 326C to the generated headers 326A and 326B. To generate the headers 326A and 326B, the ingress edge device PE1 304 may be configured to extract the error datagram from the first error packet 320. Further, the ingress edge device PE1 304 may be configured to utilize one or more headers (e.g., the IPv6 header 320B and the IPv4 header in the IPv4+Data 320C) and their extensions in the extracted error datagram to generate the outer header 326A and the inner header 326B. For example, the ingress edge device PE1 304 may generate the outer header 326A similar to the IPv6 header 320B of the extracted error datagram of the first error packet 320, with the same source address of 1::1, the same destination address of 5:1:5:F::, and a TTL value set to a default value of 64. Further, the ingress edge device PE1 304 may generate the inner header 326B by swapping the source address and the destination address of the IPv4 header in the IPv4+Data 320C of the extracted error datagram. Swapping the source address and the destination address of the IPv4 header, in the IPv4+Data 320C, to generate the inner header 326B ensures that the second error packet 326 may travel to the egress edge device PE2 312 and be forwarded back to the host device CE1 302 that is behind the ingress edge device PE1 304. The inner header 326B of the second error packet 326, therefore, may include the IP address (e.g., 2.2.2.2) of the destination device CE2 314 as a source address, the IP address (e.g., 1.1.1.1) of the host device CE1 302 as a destination address, and a TTL value set as described below. In some more embodiments, if the extracted error datagram from the first error packet 320 includes an IPv4 header as an inner header (e.g., in the IPv4+Data 320C), the ingress edge device PE1 304 may generate the second error packet 326 as an ICMPv4-PTB message. For example, as shown in FIG. 3, the inner header 326B corresponds to ICMPv4-PTB message. In still additional embodiments, the error datagram 326C of the second error packet 326 may correspond to the IPv4+Data 320C of the extracted error datagram from the first error packet 320. In further embodiments, if the extracted error datagram from the first error packet 320 includes an IPv6 header as an inner header, the ingress edge device PE1 304 may generate the second error packet 326 as an ICMPv6-PTB message.

In still further embodiments, the ingress edge device PE1 304 may update the inner header 326B of the second error packet 326 with an appropriate TTL value that ensures the second error packet 326 may expire at the ingress edge device PE1 304 when returned by the egress edge device PE2 312. In some more embodiments, the ingress edge device PE1 304 may determine and update the TTL value of the inner header 326B of the second error packet 326 based on a segment identifier END behavior associated with the second error packet 326. In an example scenario, the ingress edge device PE1 304 may determine the end behavior of the VPN-SID (e.g., 5:1:5:F::) of the egress edge device PE2 312, that is indicated in the outer header 326A of the second error packet 326. In various embodiments, to identify a matching VPN-SID end behavior, the ingress edge device PE1 304 may provide a Border Gateway Protocol (BGP) with the last SID in the SRH of the second error packet 326. In yet more embodiments, the BGP can be used for advertising segment routing policies and their associated SIDs. In SRv6, the SRH contains a list of SIDs that may define a routing path for a packet, herein, the second error packet 326. Each SID may represent a specific routing instruction or a network function. The last SID in the SRH may represent the final destination of the second error packet 326 or the last hop in the segment list before the second error packet 326 reaches its final destination or undergoes its final processing. In still yet more embodiments, the BGP can also be utilized to distribute VPN routing information across different routers. In segment routing, VPN routes are advertised with associated VPN-SIDs. When a router advertises a VPN route, the router includes the VPN-SID in a BGP UPDATE message. This allows other routers to learn which VPN-SIDs are associated with specific VPN routes. In many further embodiments, the BGP may also carry configurations or attributes that define the end behavior for the VPN-SIDs. This includes specifying actions to be taken when the VPN-SID reaches the end of its path, such as popping the VPN-SID label or forwarding the second error packet 326 to a specific endpoint.

In many additional embodiments, the matching end behavior identified by the ingress edge device PE1 304 may determine the appropriate TTL value that should be updated in the inner header 326B of the second error packet 326. For example, if the VPN-SID behavior is END. DT, the ingress edge device PE1 304 may set the TTL value to “2” in the inner header 326B of the second error packet 326 as shown in FIG. 3. In another example, if the VPN-SID behavior is END. DX, the ingress edge device PE1 304 may set the TTL value to “4” in the inner header 326B of the second error packet 326. In still yet further embodiments, the ingress edge device PE1 304 may configure the determined TTL value to expire at the ingress edge device PE1 304 upon receiving the second error packet 326 returned by the egress edge device PE2 312. In this example, the inner header 326B of the second error packet 326, therefore, may include the TTL value updated to 2.

In still yet additional embodiments, the ingress edge device PE1 304 may generate the second error packet 326 with an extension object, for example, an ICMP extension object. The extension object may correspond to a Path MTU Discovery Indicator (PMTUD-I) configured to indicate that the second error packet 326 may be intended for updating the MTU of the local segment routing policy/VPN-SID. In several embodiments, the ingress edge device PE1 304 may determine a second MTU value (denoted as “MTU2” in FIG. 3) based on the first MTU value (denoted as “MTU1” in FIG. 3) and the underlay encapsulation, and update (shown by an arrow 324) the second error packet 326 with the second MTU value. To determine the second MTU value, the ingress edge device PE1 304 may decrement a length of the underlay encapsulation from the first MTU value. For example, the ingress edge device PE1 304 may determine the second MTU value using the following equation (2):

$$[ MTU 2 ] = [ Received\_MTU1 ] - [ Extracted Error - Datagram - Outer - Header - Length ] \qquad ( 2 )$$

where, the extracted Error-Datagram-Outer-IP-Header-Length includes the IPv6 header 320B and its extensions.

In other words, from the link MTU on the intermediate device P2 308 (e.g., the first MTU value), the ingress edge device PE1 304 may subtract the additional overhead due to the underlay encapsulation and obtain the second MTU value. In an example, the link MTU may be 1500 bytes and the underlay encapsulation may be 40 bytes. The ingress edge device PE1 304 may be further configured to update the second error packet 326 with the second MTU value. For example, the ingress edge device PE1 304 may update the inner header 326B of the second error packet 326 to include the second MTU value, MTU2. As shown in FIG. 3, the ingress edge device PE1 304 may include the second MTU value, MTU2, in the ICMP-PTB message, for example, the ICMPv4-PTB message, of the second error packet 326. Thus, the ingress edge device PE1 304 may relay the second MTU value in the second error packet 326, which may account for the overhead of the underlay encapsulation. In a number of embodiments, the ingress edge device PE1 304 may be further configured to remove the outer header 320B from the error datagram of the first error packet 320 and append the resulting error datagram 326C and the extension object to the headers 326A and 326B to obtain the second error packet 326.

When the ingress edge device PE1 304 receives the first error packet 320, the ingress edge device PE1 304 may be unaware about the VRF table with which the IP address, for example, 1.1.1.1, of the host device CE1 302 is associated. However, the IPv6 header 320B of the error datagram of the first error packet 320 may include the VPN-SID allocated to the egress edge device PE2 312, which may be associated with the correct VRF table associated with the IP address of the host device CE1 302. Thus, in order to identify the correct VRF table associated with the IP address of the host device CE1 302 for relaying the second error packet 326 to the host device CE1 302, the ingress edge device PE1 304 may generate the second error packet 326 with the VPN-SID of the egress edge device PE2 312 indicated as the destination address in the outer header 326A and the IP address of the host device CE1 302 indicated as the destination address in the inner header 326B. Accordingly, in many additional embodiments, the ingress edge device PE1 304 may transmit the generated second error packet 326 towards its destination, that is, towards the egress edge device PE2 312. For example, the ingress edge device PE1 304 may transmit the generated second error packet 326 towards the egress edge device PE2 312 based on the VPN-SID of the egress edge device PE2 312 indicated in the destination address field of the outer header 326A.

Upon receiving the second error packet 326, the egress edge device PE2 312 may be configured to perform a lookup in a VRF table, corresponding to the VPN-SID of the egress edge device PE2 312, for the destination address, for example, 1.1.1.1, indicated in the inner header 326B of the second error packet 326. This lookup may result in the VPN-SID of the ingress edge device PE1 304 that is being utilized for SRv6 encapsulation. The egress edge device PE2 312 may further determine that the destination address, for example, 1.1.1.1, indicated in the inner header 326B of the second error packet 326 is reachable via the ingress edge device PE1 304. Thus, the egress edge device PE2 312 may replace the outer header 326A of the second error packet 326 with another outer header 326D. Replacement of the outer header 326A with the other outer header 326D is indicated by an arrow 328 in FIG. 3. The other outer header 326D may include the IP address (e.g., 5::5) of the egress edge device PE2 312 as the source address, the VPN-SID (e.g., 5:1:1:F::) of the ingress edge device PE1 304 as the destination address, in the other outer header 326D of the second error packet 326. The egress edge device PE2 312 may then transmit the second error packet 326 in which the outer header 326A is replaced with the other outer header 326D towards its destination, that is, the ingress edge device PE1 304. As a result, when the ingress edge device PE1 304 receives the second error packet 326, the ingress edge device PE1 304 can now determine how to route the second error packet 326 utilizing the correct VRF table. In further embodiments, when the ingress edge device PE1 304 receives the second error packet 326, the TTL value in the outer header 326D of the second error packet 326 may, for example, be 61.

In still more embodiments, as the TTL value in the inner header 326B of the second error packet 326 is 1, the TTL value may expire at the ingress edge device PE1 304 once outer IPv6 encapsulation is removed. In response to the expiration of the TTL value in the inner header 326B and due to the presence of the extension object, PMTUD-I, the ingress edge device PE1 304 may punt the second error packet 326 to the control data plane including a central processing unit (CPU). In still further embodiments, the punting process may include using the received outer header 326D of the second error packet 326 to identify the correct VRF table, and then, with the identified VRF table, looking up the destination address, for example, 1.1.1.1, indicated in the inner header 326B of the second error packet 326 in the specific VRF forwarding table to identify the affected segment routing policy/VPN-SID. In still additional embodiments, the destination address, for example, 5:1:1:F::, in the outer header 326D of the second error packet 326, may indicate the local VPN. In some more embodiments, the ingress edge device PE1 304 may update (shown by an arrow 330) the second MTU value, MTU2, in the affected segment routing policy. In various embodiments, the ingress edge device PE1 304 may optionally forward (shown by an arrow 332) the second error packet 326 towards the host device CE1 302 by updating the TTL value in the inner header 326B of the second error packet 326.

Consider an example scenario for optionally updating the MTU of a segment routing policy, for example, a local SRv6 policy, on the ingress edge device PE1 304. In this example scenario, the egress edge device PE2 312 may decrement the TTL for the inner header 326B of the second error packet 326 such that the TTL value expires at the ingress edge device PE1 304 and the second error packet 326 gets punted to the control plane. On the ingress edge device PE1 304, the control plane may examine the presence of the extension object and, if present, perform a lookup on the destination address (for example, 1.1.1.1), included in the inner header 326B, in the VRF table associated with the VPN-SID of the ingress edge device PE1 304 present in the outer header 326D of the second error packet 326. Based on the lookup, the ingress edge device PE1 304 can identify the segment routing policy corresponding to the destination address, for example, 1.1.1.1, and update the MTU value of the identified segment routing policy. With this, a second host device using the same segment routing policy may receive the ICMP-PTB error directly from the ingress edge device PE1 304 instead of having to relay the ICMP-PTB error to the egress edge device PE2 312 and back.

Although a specific embodiment for identifying a segment routing policy associated with a host device and updating a resultant MTU value in the segment routing policy suitable for carrying out the various steps, processes, methods, and operations described herein is discussed with respect to FIG. 3, any of a variety of systems and/or processes may be utilized in accordance with embodiments of the disclosure. For example, in cases where there is no SRH in the second error packet, in various embodiments, to identify a matching VPN-SID end behavior, the ingress edge device PE1 304 may provide the BGP with a destination IP address, thereby allowing determination of an appropriate TTL value to be updated in the inner header 326B of the second error packet 326. The elements depicted in FIG. 3 may also be interchangeable with other elements of FIG. 1-2 and FIG. 3-11 as required to realize a particularly desired embodiment.

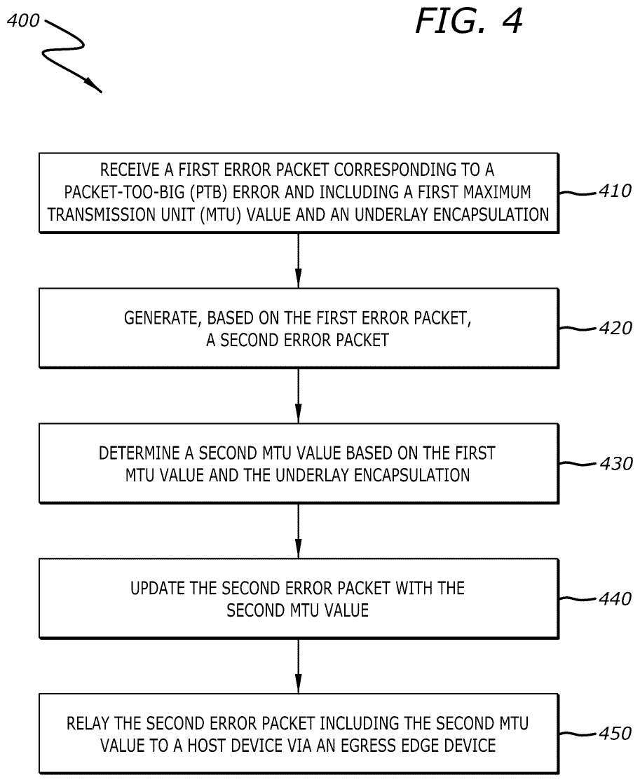

Referring to FIG. 4, a flowchart depicting a process 400 for relaying an error packet including a resultant MTU value to a host device via an egress edge device in accordance with various embodiments of the disclosure is shown. When a host device transmits packets via an overlay network, a link in an underlay network may fail to forward an encapsulated packet due to its size exceeding the MTU of the link. In this example scenario, assuming an IPv6 underlay, an underlay node may generate a PTB error packet and provide the PTB error packet to the host device via provider edge devices. The provider edge devices may include an ingress edge device and an egress edge device. The host device, the provider edge devices, intermediate provider devices, and a destination device may operate in a network system. In a number of embodiments, the network system can be configured to provide enhanced error handling for ICMPv6, which is a protocol resulting from IPv6 using ICMP with some changes. In many embodiments, the ingress edge device may be communicatively coupled to the host device, and to the egress edge device via one or more intermediate provider devices. In a variety of embodiments, the provider edge devices and the intermediate provider devices may be provisioned in a segment routing domain with segment routing capabilities, such that they provide a path for network traffic between the host device and the destination device. The host device and the destination device may, for example, be customer edge routers. In segment routing scenarios, certain errors associated with a packet traversing the segment routing domain may occur and cause an error packet to be generated and reported to the host device.

Consider an example scenario where a node such as an intermediate provider device located between an ingress edge device and an egress edge device, may fail to forward a packet encapsulated by the ingress edge device due to the size of the packet exceeding the link MTU of the intermediate provider device. In this example scenario, the intermediate provider device may generate and transmit a first error packet corresponding to the PTB error, for example, an ICMP-PTB error, to the ingress edge device for relaying to the host device.

In various embodiments, the process 400 may receive the first error packet corresponding to the PTB error, and including a first MTU value and an underlay encapsulation (block 410). In the above example scenario, the PTB error may occur at the intermediate provider device when a packet size is determined to be more than the MTU associated with the physical link between the intermediate provider device and the next intermediate provider device in a network path. In several embodiments, the first error packet may be generated, for example, according to ICMPv6. The first MTU value may refer to the size (in bytes) of the largest packet that can pass along the network path of the segment routing domain between the host device and the destination device. The underlay encapsulation may introduce an additional overhead including added bytes to the first error packet. The added bytes may be included in a packet header of the first error packet. In numerous embodiment, the first error packet may include a header and an error datagram.

In more embodiments, the process 400 may generate, based on the first error packet, a second error packet (block 420). In yet various embodiments, the process 400 may generate the second error packet according to an IP protocol of an inner header of the error datagram included in the first error packet. For example, the second error packet may be generated according to ICMPv4, if the inner header of the error datagram is IPv4. In another example, the second error packet may be generated according to ICMPv6, if the inner header of the error datagram is IPv6. In yet more embodiments, the generated second error packet may include an inner header including a source address field and a destination address field, and an outer header including a source address field and a destination address field. In additional embodiments, the process 400 may set TTL values of the inner header and the outer header of the second error packet to default TTL values. In further embodiments, to generate the second error packet, the process 400 may swap data of the source address field and the destination address field in the inner header of the second error packet. As a result of swapping, the destination address field in the inner header of the second error packet may include an IP address of the host device as destination. In still more embodiments, the process 400 may include a segment identifier of the egress edge device as a destination in the destination address field of the outer header of the second error packet. In an example, the segment identifier may be a VPN-SID.

In still additional embodiments, the process 400 may determine a second MTU value based on the first MTU value and the underlay encapsulation (block 430). In some more embodiments, the process 400 may determine the second MTU value by decrementing a length of the underlay encapsulation from the first MTU value. In an example where the link MTU is 1500 bytes and the underlay encapsulation is 40 bytes, the process 400 may determine the second MTU value as (1500−60)=1440 bytes. In numerous additional embodiments, the process 400 may update the second error packet with the second MTU value (block 440). In the above example, the process 400 may set the second MTU value in the second error packet to 1440 bytes instead of 1500 bytes of the link MTU. The second MTU value may be referred to as a resultant MTU value. Further, the second MTU value may be included in the inner header of the second error packet.

In several more embodiments, the process 400 may relay the second error packet including the second MTU value to the host device via the egress edge device (block 450). In still several additional embodiments, to relay the second error packet to the host device via the egress edge device, the process 400 may transmit, to the egress edge device, the second error packet including the segment identifier of the egress edge device as the destination in the outer header and the IP address of the host device as the destination in the inner header. The egress edge device may determine that the destination address in the inner header of the second error packet can be reached via the ingress edge device. Thus, the egress edge device may replace the outer header of the second error packet with a new outer header. The new outer header may include a segment identifier (e.g., a VPN-SID) of the ingress edge device as a destination in the new outer header. In many further embodiments, the process 400 may receive, from the egress edge device, the second error packet in which the outer header is replaced by the new outer header including the segment identifier of the ingress edge device. The process 400 may remove the other outer header from the second error packet and transmit the second error packet including the second MTU value (e.g., the resultant MTU value) to the host device. Consequently, the host device may fragment subsequent packets for the destination device in accordance with the second MTU value.

Although a specific embodiment for a process 400 for relaying an error packet including a resultant MTU value to a host device via an egress edge device suitable for carrying out the various steps, processes, methods, and operations described herein is discussed with respect to FIG. 4, any of a variety of systems and/or processes may be utilized in accordance with various embodiments of the disclosure. For example, the value of the MTU relayed back in the second error packet may account for the overhead of multiple different types of SRv6 encapsulations including, for example, SRv6 IPv6-in-IPv6 encapsulation, SRv6 IPv4-in-IPv6 encapsulation, SRv6 MPLS-in-IPv6 encapsulation, SRv6 Ethernet-in-IPv6 encapsulation, SRv6 Virtual Extensible Local Area Network (VXLAN)-in-IPv6 encapsulation, or the like. The elements depicted in FIG. 4 may also be interchangeable with other elements of FIG. 1-3 and FIG. 5-11 as required to realize a particularly desired embodiment.

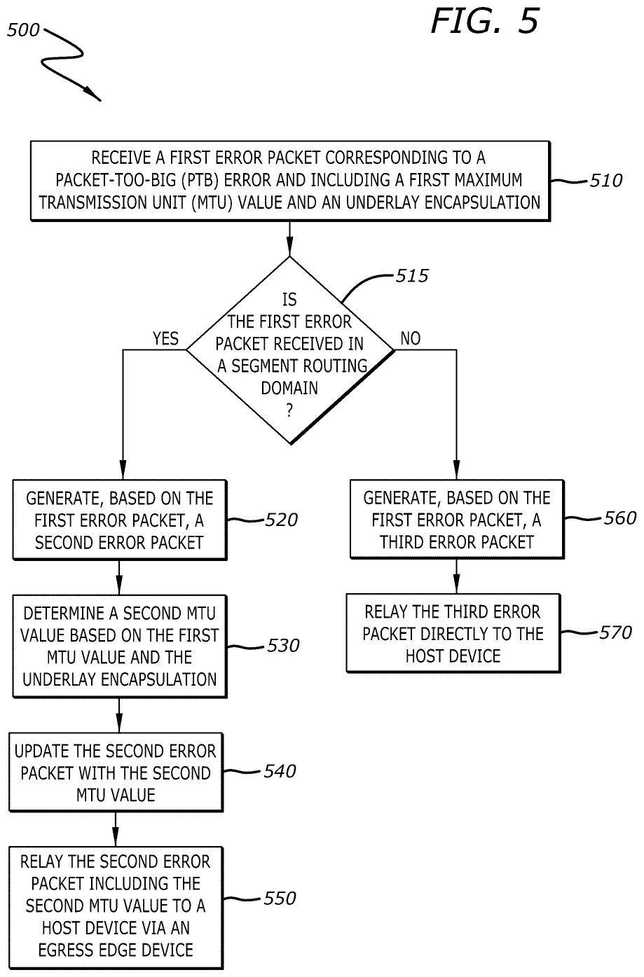

Referring to FIG. 5, a flowchart depicting a process 500 for relaying an error packet including a resultant MTU value to a host device in accordance with various embodiments of the disclosure is shown. Consider an example scenario where a node such as an intermediate device located between an ingress edge device and an egress edge device, may fail to forward a packet encapsulated by the ingress edge device due to the size of the packet exceeding a link MTU of the intermediate device, and therefore, may generate and transmit a first error packet corresponding to a PTB error to the ingress edge device.

In many embodiments, the process 500 may receive the first error packet corresponding to the PTB error (block 510) and including a first MTU value and an underlay encapsulation. The PTB error may, for example, be an ICMP-PTB error. The underlay encapsulation may include the bytes added to the first error packet, which may be included in a packet header of the first error packet. The first MTU value may indicate a size of the largest packet supported by a link of the intermediate device.

In a number of embodiments, the process 500 may determine whether the first error packet is received in a segment routing domain (block 515). The segment routing domain may refer to a network segment or area within which segment routing is utilized to manage and route traffic. Segment routing may allow a node to steer a packet through a controlled set of instructions, called segments, by prepending an SRH to the packet. A segment can represent any (forwarding) instruction, topological or service-based. Segment routing may allow for steering of a flow through any path (topological or service/application based) while maintaining a per-flow state only at an ingress node of the segment routing domain. The list of segments defining an end-to-end forwarding path of the flow packets is called a segment list, which may be encoded in the SRH of the packet. The segment routing domain may also be referred to as a segment routing network including a set of nodes participating in a source-based routing model. These nodes may be connected to the same physical infrastructure (e.g.: a service provider's network) as well as nodes remotely connected to each other (e.g., an enterprise VPN or an overlay).

In a variety of embodiments, in response to determining that the first error packet is received in a segment routing domain, the process 500 may generate, based on the first error packet, a second error packet (block 520). When the ingress edge device receives the first error packet corresponding to the PTB error, the process 500 may extract an error datagram from the first error packet and utilize one or more headers in the error datagram to generate the second error packet. The second error packet may include an outer header, an inner header, and an error datagram. In numerous embodiments, the process 500 may generate the outer header and the inner header of the second error packet by utilizing an outer header and an inner header, respectively, of the error datagram of the first error packet including an extension. To generate the inner header of the second error packet, the process 500 may swap a source address and a destination address of the inner header of the error datagram of the first error packet. Swapping the source address and the destination address in the inner header of the error datagram may ensure that the second error packet travels to the egress edge device and be forwarded back to the host device that is behind the ingress edge device.

In more embodiments, the process 500 may determine a second MTU value based on the first MTU value and the underlay encapsulation (block 530). In additional embodiments, the process 500 may determine the second MTU value by decrementing a length of the underlay encapsulation from the first MTU value. The length of the underlay encapsulation may, for example, refer to the length of an outer header of the error datagram of the first error packet. For example, the process 500 may determine the second MTU value by utilizing the following formula: [Second MTU value]=[First MTU Value]−[Error-Datagram-Outer-Header-Length], where the Error-Datagram-Outer-IP-Header-Length may include IPv6 header extensions in the error datagram of the first error packet. In several embodiments, the process 500 may update the second error packet with the second MTU value (block 540). For example, the process 500 may include the second MTU value in the inner header of the second error packet.

In yet more embodiments, the process 500 may relay the second error packet including the second MTU value to the host device via the egress edge device (block 550). In still yet more embodiments, the process 500 may transmit the generated second error packet towards the egress edge device based on the VPN-SID of the egress edge device indicated in a destination address field of the outer header of the second error packet. In many further embodiments, based on the VPN-SID of the egress edge device, the egress edge device may perform a VRF lookup on a destination address indicated in the inner header of the second error packet and forward the second error packet back to the host device that is behind ingress edge device.

However, in many additional embodiments, in response to determining that the first error packet is not received in the segment routing domain, the process 500 may generate, based on the first error packet, a third error packet (block 560). Routing domains other than the segment routing domain may provide a source address associated with an offending or affected segment routing policy or VPN-SID in an encapsulated error packet, and hence may provide context for relaying the error packet back to the host device. The VPN-SID may correspond to the correct VRF table that the ingress edge device needs to know to identify the IP address of the host device and route the error packet to the host device. When the ingress edge device receives the first error packet in another routing domain, for example, an MPLS routing domain, the process 500 may identify the correct VRF table associated with the VPN-SID available in the first error packet. Thus, upon receiving the first error packet, the process 500 may perform a lookup in the VRF table corresponding to the VPN-SID for the IP address of the host device, and therefore knows how to route the packet to the correct VRF table. The third error may correspond to an ICMP-PTB message compatible with an IP protocol of the host device. For example, the first received error packet can be an ICMPv6-PTB message and the host device may support IPv4 protocol. In such a scenario, the third error packet may be an ICMPv4-PTB message generated based on the received ICMPv6-PTB message. However, in another example, the first received error packet can be an ICMPv4-PTB message and the host device may support IPv6 protocol. In such a scenario, the third error packet may be an ICMPv6-PTB message generated based on the received ICMPv4-PTB message.

In still yet further embodiments, the process 500 may relay the third error packet directly to the host device (block 570). As the ingress edge device is aware of how to route the packet to the correct VRF table, by performing a lookup in the VRF table corresponding to the VPN-SID for the IP address of the host device, the process 500 may be capable of relaying the third error packet directly to the host device. In these embodiments, the process 500 may not need to relay the third error packet to the host device via the egress edge device.

Although a specific embodiment for a process 500 for relaying an error packet including a resultant MTU value to a host device suitable for carrying out the various steps, processes, methods, and operations described herein is discussed with respect to FIG. 5, any of a variety of systems and/or processes may be utilized in accordance with embodiments of the disclosure. For example, the network devices associated with nodes at the edge of a segment routing domain may be adapted to use approaches and protocols not involving segment routing in addition to using segment routing. Such network devices may be adapted to use, for example, IP routing or MPLS with a Label Distribution Protocol (LDP) in addition to segment routing. The elements depicted in FIG. 5 may also be interchangeable with other elements of FIG. 1-4 and FIG. 6-11 as required to realize a particularly desired embodiment.

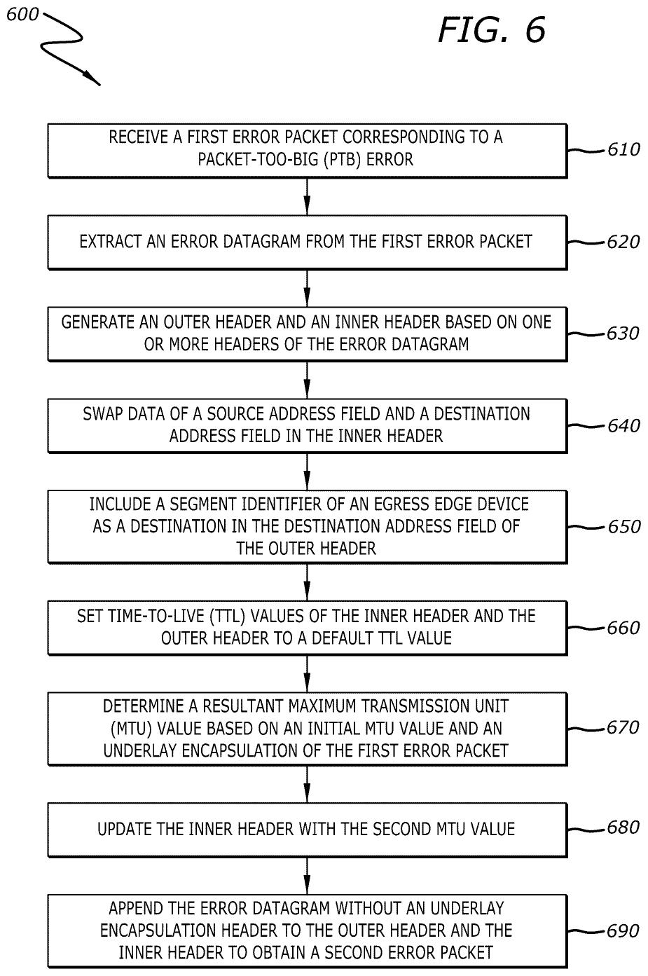

Referring to FIG. 6, a flowchart depicting a process 600 for generating an error packet including a resultant MTU value in accordance with various embodiments of the disclosure is shown. In many embodiments, the process 600 may receive a first error packet corresponding to a PTB error (block 610). One of the intermediate devices between an ingress edge device and an egress edge device may generate the first error packet corresponding to the PTB error, due to the size of an incoming, encapsulated packet, for example, an IPv6 packet, exceeding the link MTU of the intermediate device. In an example, the first error packet may correspond to an ICMPv6-PTB error and may be referred to as an ICMPv6-PTB error packet. The intermediate device may encapsulate the IPv6 packet inside the first error packet by adding, for example, an IPv6+ICMPv6-PTB header and embedding the original IPv6 packet inside a payload of the first error packet. In a variety of embodiments, the payload of the first error packet may be referred to as an “error datagram” of the first error packet. The intermediate device may transmit the first error packet to the ingress edge device. In

In a number of embodiments, the process 600 may extract the error datagram from the first error packet (block 620). When the ingress edge device receives the first error packet from the intermediate device in a segment routing domain, the process 600 may proceed to generate a second error packet. The process 600 may examine the first error packet to identify the protocol used. In an example, the process 600 may identify the protocol as ICMP by examining the first error packet. If the process 600 identifies the protocol as ICMP, the process 600 may check an ICMP type and code fields to determine the type of ICMP error associated with the first error packet. When the type of ICMP error is determined, the process 600 may parse the first error packet to extract the error datagram. For example, in the ICMP, the error packet may encapsulate a portion of the original packet that caused the error. The process 600 may extract this original packet to understand the context of the error.

In several embodiments, the process 600 may generate an outer header and an inner header based on one or more headers of the error datagram (block 630). After extraction of the error datagram from the first error packet, the process 600 may utilize the headers (e.g., outer and inner headers) in the error datagram to generate the second error packet. In several more embodiments, the process 600 may generate a header for the second error packet using an outer header and an inner header of the error datagram of the first error packet including an extension. The header of the second error packet may include the outer header that is similar to the outer header of the error datagram of the first error packet, and the inner header.

In numerous embodiments, the process 600 may swap data of a source address field and a destination address field in the inner header of the second error packet (block 640). In more embodiments, to swap the data of the source address field and the destination address field in the inner header of the second error packet, the process 600 may store the original source address in a temporary variable, replace the value in the source address field with the value from the destination address field, and replace the value in the destination address field with the value stored in the temporary variable. Swapping the data of the source address field and the destination address field in the inner header of the second error packet may ensure that the second error packet travels to the egress edge device and be forwarded to the host device that is behind the ingress edge device. In an example, after swapping, the source address field may contain an IP address of a destination device and the destination address field may contain an IP address of the host device.

In additional embodiments, the process 600 may include a segment identifier of the egress edge device as a destination in a destination address field of the outer header of the second error packet (block 650). For example, the process 600 may include a VPN-SID of the egress edge device as the destination in the destination address field of the outer header of the second error packet. For example, when the ingress edge device receives the first error packet, the ingress edge device may be unaware about a VRF table with which the address (e.g., IP address) of the host device is associated. However, the outer header of the error datagram of the first error packet may contain the VPN-SID allocated to the egress edge device, which may be associated with the correct VRF table associated with the address of the host device. Accordingly, the process 600 may include the VPN-SID of the egress edge device as the destination address in the outer header of the second error packet to enable utilization of the correct VRF table associated with the address of the host device.

In further embodiments, the process 600 may set TTL values of the inner header and the outer header to a default TTL value (block 660). For example, if the TTL values in the outer header and the inner header of the incoming first error packet are 64 and FF, the process 600 may set the TTL values of the outer header and the inner header of the second error packet to 64 and FF, respectively.

In still more embodiments, the process 600 may determine a resultant MTU value based on an initial MTU value and an underlay encapsulation of the first error packet (block 670). In still additional embodiments, for determining the resultant MTU value, the process 600 may decrement a length of the underlay encapsulation from initial MTU value. Consider an example where the initial MTU value is 1500 bytes and the underlay encapsulation is 40 bytes. In this example, second MTU value can be set to (1400−40)=1360 bytes instead of 1400 bytes. In some more embodiments, the process 600 may update the inner header of the second error packet with the second MTU value (block 680).

In many further embodiments, the process 600 may append the error datagram without an underlay encapsulation header to the outer header and the inner header to obtain the second error packet (block 690). The second error packet, therefore, may include the outer header, the inner header, and the appended error datagram without the underlay encapsulation header. The outer header of the second error packet may include the same source address and destination address as the outer header of the error datagram of the first error packet, and a default TTL value. The inner header of the second error packet may include swapped data in the source address field and the destination address field, a default TTL value, and the resultant MTU value.

Although a specific embodiment for a process 600 for generating an error packet including a resultant MTU value suitable for carrying out the various steps, processes, methods, and operations described herein is discussed with respect to FIG. 6, any of a variety of systems and/or processes may be utilized in accordance with embodiments of the disclosure. For example, if the inner header of the error datagram of the first error packet is a header of another protocol of a future version different from IPv4 and IPv6, the process 600 may generate an ICMP-PTB message associated with the other protocol of the future version for inclusion in the second error packet. The elements depicted in FIG. 6 may also be interchangeable with other elements of FIG. 1-5 and FIG. 7-11 as required to realize a particularly desired embodiment.

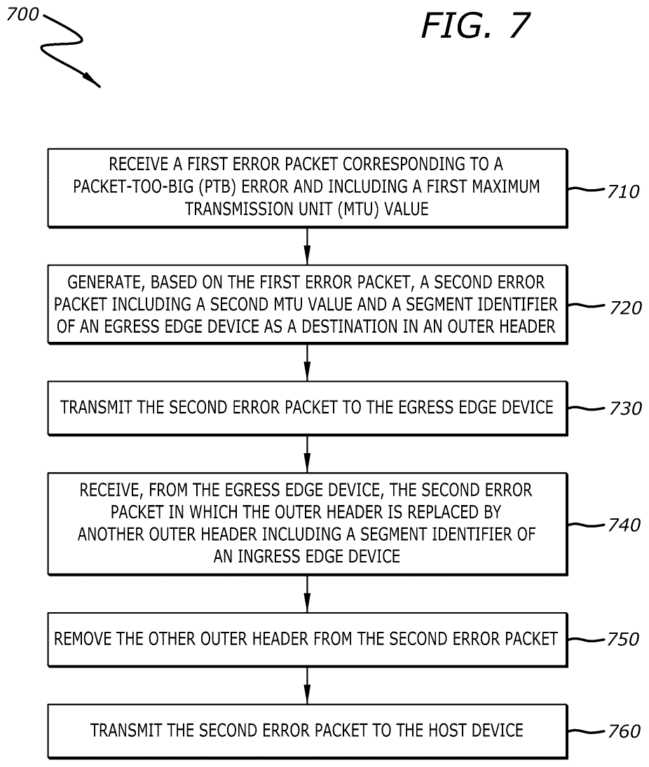

Referring to FIG. 7, a flowchart depicting a process 700 for relaying an error packet including a resultant MTU value to a host device via an egress edge device in accordance with various embodiments of the disclosure is shown. Consider an example scenario where a node such as an intermediate device located between an ingress edge device and an egress edge device, may fail to forward a packet encapsulated by the ingress edge device due to the size of the packet exceeding a link MTU of the intermediate device, and therefore, may generate and transmit a first error packet corresponding to a PTB error to the ingress edge device.

In many embodiments, the process 700 may receive the first error packet corresponding to the PTB error and including a first MTU value (block 710). In the above example scenario, the PTB error may occur at the intermediate device when a packet size is determined to be more than an MTU associated with a physical link between the intermediate device and a next intermediate device in a network path. The first error packet may include the first MTU value and an underlay encapsulation. The first MTU value may refer to the size (in bytes) of the largest packet that can pass along the network path of a segment routing domain between the host device and a destination device. The underlay encapsulation may introduce an additional overhead including added bytes to the first error packet.

In a number of embodiments, the process 700 may generate, based on the first error packet, a second error packet including a second MTU value and a segment identifier of an egress edge device as a destination in an outer header (block 720). In a variety of embodiments, the process 700 may obtain the first MTU value from the first error packet, and then determine the second MTU value by decrementing a length of the underlay encapsulation from the first MTU value. In several embodiments, the process 700 may include the segment identifier, for example, a VPN-SID, of the egress edge device as a destination in the outer header of the second error packet. When ingress edge device receives the first error packet, the ingress edge device may be unaware about a VRF table with which the address of the host device is associated. However, the first error packet may contain the VPN-SID allocated to the egress edge device, which may be associated with the correct VRF table associated with the address of the host device. Accordingly, in more embodiments, the process 700 may generate the second error packet with the VPN-SID of the egress edge device as the destination address in the outer header of the second error packet.

In additional embodiments, the process 700 may transmit the second error packet to the egress edge device (block 730). Based on the VPN-SID of the egress edge device included as the destination address in the second error packet, the process 700 may transmit the second error packet to the egress edge device. In further embodiments, upon receiving the second error packet, the egress edge device may perform a lookup in the VRF table, corresponding to the VPN-SID of the egress edge device, for a destination address indicated in an inner header of the second error packet. This lookup may result in a segment identifier (e.g., a VPN-SID) of the ingress edge device being utilized for SRv6 encapsulation. As the destination address indicated in the inner header of the second error packet may be reachable via the ingress edge device, the egress edge device may utilize an encapsulation of the VPN-SID of the ingress edge device in the second error packet and forward the second error packet towards the ingress edge device. That is, in addition to the source address of the egress edge device, the egress edge device may include the VPN-SID of the ingress edge device in the outer header of the second error packet.

In still more embodiments, the process 700 may receive, from the egress edge device, the second error packet in which the outer header is replaced by another outer header including a segment identifier of the ingress edge device (block 740). In still further embodiments, the segment identifier of the ingress edge device may be associated with the VRF table corresponding to an IP address of the host device. When the ingress edge device receives the returned second error packet, the process 700 may determine how to route the second error packet to the correct VRF table. In many further embodiments, the process 700 may remove the other outer header from the second error packet (block 750). The process 700 may examine the outer header to determine the type of encapsulation, and analyze the fields within the outer header to identify where the original packet, that is, the inner packet starts. In yet additional embodiments, the process 700 may then remove the outer header from the second error packet by updating a data buffer of the second error packet to discard the outer header information and adjust pointers or lengths accordingly.

In still additional embodiments, the process 700 may transmit the second error packet to the host device (block 760). In some more embodiments, the process 700 may transmit the second error packet to the host device based on the VRF table associated with the segment identifier of the ingress edge device. In numerous embodiments, the second error packet transmitted to the host device may include the inner header with the ICMP-PTB message and an ICMP error datagram including a part of the original packet used for identifying the original packet that could not be forwarded by the intermediate device. In yet more embodiments, the process 700 may relay the second error packet from an SRv6 core network to the host device by updating the relevant SRv6encapsulation overhead to the original MTU set in the first error packet.

Although a specific embodiment for a process 700 for relaying an error packet including a resultant MTU value to a host device via an egress edge device suitable for carrying out the various steps, processes, methods, and operations described herein is discussed with respect to FIG. 7, any of a variety of systems and/or processes may be utilized in accordance with embodiments of the disclosure. For example, as opposed to relaying an error packet including a resultant MTU value determined using a single underlay encapsulation, the process 700 may relay an error packet including a resultant MTU value determined using multiple different types of encapsulation such as Generic Routing Encapsulation (GRE) or VPN encapsulation, or any network protocol headers such as IP or MPLS headers, and link layer overheads like Ethernet or other framing protocols. The elements depicted in FIG. 7 may also be interchangeable with other elements of FIG. 1-6 and FIG. 8-11 as required to realize a particularly desired embodiment.

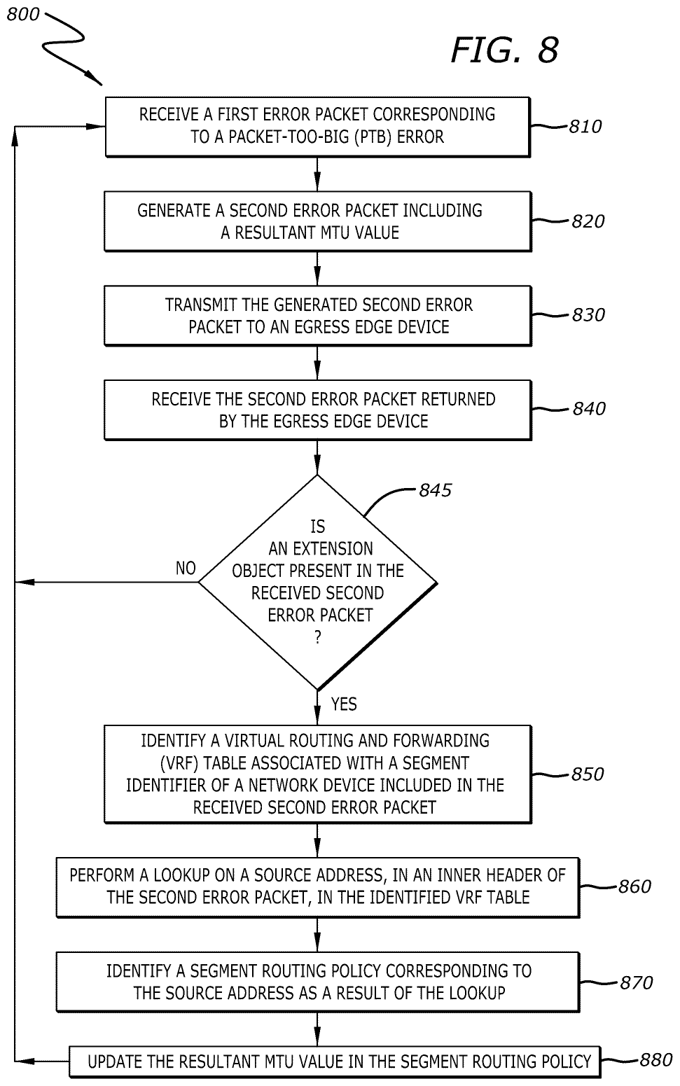

Referring to FIG. 8, a flowchart depicting a process 800 for identifying a segment routing policy associated with a host device and updating a resultant MTU value in the segment routing policy in accordance with various embodiments of the disclosure is shown. In many embodiments, the process 800 may identify the affected local segment routing policy and/or segment identifier on a provider edge headend, for example, an ingress edge device, and update their MTU value, respectively. The segment routing policy may, for example, be an SRv6 policy. The segment identifier may, for example, be a VPN-SID. In a number of embodiments, the hop-limit propagation may not be enabled on provider edge devices in a segment routing domain. Consider an example scenario where a node such as an intermediate device located between the ingress edge device and an egress edge device, may fail to forward a packet encapsulated by the ingress edge device due to the size of the packet exceeding a link MTU of the intermediate device. In this example scenario, the intermediate device may generate and transmit a first error packet corresponding to a PTB error, for example, an ICMP-PTB error, to the ingress edge device.

In a variety of embodiments, the process 800 may receive the first error packet corresponding to a PTB error (block 810). In the above example scenario, the PTB error may occur at the intermediate device when a packet size is determined to be more than the MTU associated with the physical link between the intermediate device and the next intermediate device in a network path. The first error packet may include an initial MTU value and an underlay encapsulation. The first MTU value may refer to the size (in bytes) of the largest packet that can pass along the network path of the segment routing domain between the host device and the destination device. The underlay encapsulation may introduce an additional overhead including added bytes to the first error packet.

In several embodiments, the process 800 may generate a second error packet including a resultant MTU value (block 820). In more embodiments, the process 800 may obtain the initial MTU value from the first error packet, and then determine the resultant MTU value. For example, the process 800 may determine the resultant MTU value based on the initial MTU value and the underlay encapsulation, and update the second error packet with the resultant MTU value. In additional embodiments, for determining the resultant MTU value, the process 800 may decrement a length of the underlay encapsulation from the initial MTU value. In further embodiments, the process 800 may include a segment identifier, for example, a VPN-SID, of the egress edge device as a destination in an outer header of the second error packet. For example, when the ingress edge device receives the first error packet, the process 800 may be unaware about a VRF table with which an address of the host device is associated. However, the first error packet may contain a VPN-SID allocated to the egress edge device, which may be associated with the correct VRF table associated with the address of the host device. Accordingly, in still more embodiments, the process 800 may generate the second error packet with the VPN-SID of the egress edge device as the destination address in the second error packet to enable identification of the correct VRF table associated with the address of the host device.

In still further embodiments, the process 800 may transmit the generated second error packet to the egress edge device (block 830). Based on the VPN-SID of the egress edge device included as the destination address in the second error packet, the process 800 may transmit the second error packet to the egress edge device. In still additional embodiments, upon receiving the second error packet, the egress edge device may perform a lookup in the VRF table, corresponding to the VPN-SID of the egress edge device, for a destination address indicated in an inner header of the second error packet. This lookup may result in the VPN-SID of the ingress edge device being used for SRv6 encapsulation. As the destination address indicated in the inner header of the second error packet may be reachable via the ingress edge device, the egress edge device may utilize the encapsulation of the VPN-SID of the ingress edge device in the second error packet and forward the second error packet towards the ingress edge device. That is, in addition to the source address of the egress edge device, the egress edge device may include the VPN-SID of the ingress edge device in the outer header of the second error packet. In yet more embodiments, prior to transmitting the generated second error packet to the egress edge device, the process 800 may set a TTL value of the outer header of the second error packet to a default TTL value. In some more embodiments, the egress edge device may decrement the TTL value for the inner header of the second error packet such that the TTL value expires at the ingress edge device and gets punted to a control plane. Punting may refer to a process where a network device, such as a switch or a router, forwards a packet to the control plane for processing, rather than handling the packet in a data plane.

In various embodiments, the process 800 may receive the second error packet returned by the egress edge device (block 840). In still yet more embodiments, the process 800 may receive, from the egress edge device, the second error packet in which the outer header is replaced by another outer header including the segment identifier, for example, the VPN-SID, of the ingress edge device. In several additional embodiments, the segment identifier of the ingress edge device may be associated with the VRF table corresponding to the IP address of the host device. When the ingress edge device receives the second error packet, the process 800 may determine how to route the second error packet to the correct VRF table.

In many further embodiments, the process 800 may determine whether an extension object is present in the received second error packet (block 845). In many additional embodiments, the process 800 may have generated the second error packet with an extension object, for example, an ICMP extension object. The extension object may indicate a requirement for a segment routing policy update for the resultant MTU value. The extension object may correspond to a Path MTU Discovery Indicator (PMTUD-I) configured to indicate that the second error packet may be intended for updating the MTU of the local segment routing policy/VPN-SID. In still yet further additional embodiments, when the TTL expires at the ingress edge device and due to the presence of the extension object, PMTUD-I, the process 800 may punt the second error packet to the control plane. In still yet additional embodiments, the control plane may include a central processing unit (CPU) or a controller configured to examine the second error packet for the extension object.

In still yet further embodiments, in response to determining that the extension object is present in the received second error packet, the process 800 may identify the VRF table associated with the segment identifier of the ingress edge device included in the received second error packet (block 850). The segment identifier is, for example, the VPN-SID of the ingress edge device. The process 800 may examine the extension object, for example, PMTUD-I, which may indicate that the received second error packet may be intended for updating the MTU of the local segment routing policy/VPN-SID. In an example, the local segment routing policy/VPN-SID may be associated with the ingress edge device as indicated by the VPN-SID of the ingress edge device present in the destination address of the outer header of the received second error packet.

In several more embodiments, the process 800 may perform a lookup on a destination address, in the inner header of the second error packet, in the identified VRF table (block 860). For example, if the extension object is present in the received second error packet, the process 800 may perform a lookup on the IP address of the host device in the VRF table associated with the VPN-SID of the ingress edge device. The IP address of the host device may be present as the destination address in the inner header of the received second error packet. The VPN-SID of the ingress edge device may be present in the outer header of the received second error packet.

In yet various embodiments, the process 800 may identify a segment routing policy corresponding to the destination address, in the inner header, as a result of the lookup (block 870). In numerous additional embodiments, in response to the received second error packet including the extension object, the process 800 may identify the segment routing policy associated with the host device and update the resultant MTU value in the segment routing policy. In further additional embodiments, the punting process may include using the received outer header of the second error packet to identify the VRF table, and then, with the identified VRF table, looking up the destination address indicated in the inner header of the second error packet, which is the IP address of the host device, in the specific VRF forwarding table to identify the affected segment routing policy/VPN-SID. In yet further additional embodiments, the process 800 may update the resultant MTU value in the segment routing policy (block 880), and return to receiving a new first error packet corresponding to a PTB error (block 810).

However, in yet additional embodiments, in response to determining that the extension object is not present in the received second error packet, the process 800 may return to receiving a first error packet corresponding to a PTB error (block 810), and the process 800 repeats. In yet numerous embodiments, the provider edge headend, for example, the ingress edge device, may respond to the received first error packet corresponding to the PTB error. However, the provider edge headend cannot distinguish whether the PTB error in the first error packet is a legitimate ICMP-PTB error or a part of an attack. Therefore, in yet several embodiments, before updating the MTU value of the segment routing policy and/or the VPN-SID to the resultant MTU value, performance measurement can be utilized for validating the first error packet corresponding to the PTB error by sending a performance measurement packet with the respective data that exceeds the received initial MTU value. If the provider edge headend receives another first error packet from the same node, the provider edge headend assumes that the previously received first error packet is legitimate.

Although a specific embodiment for a process 800 for identifying a segment routing policy associated with a host device and updating a resultant MTU value in the segment routing policy suitable for carrying out the various steps, processes, methods, and operations described herein is discussed with respect to FIG. 8, any of a variety of systems and/or processes may be utilized in accordance with embodiments of the disclosure. For example, before updating the MTU value of the segment routing policy and/or the VPN-SID to resultant MTU value, any mechanism such as checksum validation, source address verification, validating the portion of the original packet that caused the error, ICMP type and code verification, TTL and Hop-limit checks, or the like, may be utilized to validate the first error packet corresponding to the PTB error. The elements depicted in FIG. 8 may also be interchangeable with other elements of FIG. 1-7 and FIG. 9-11 as required to realize a particularly desired embodiment.

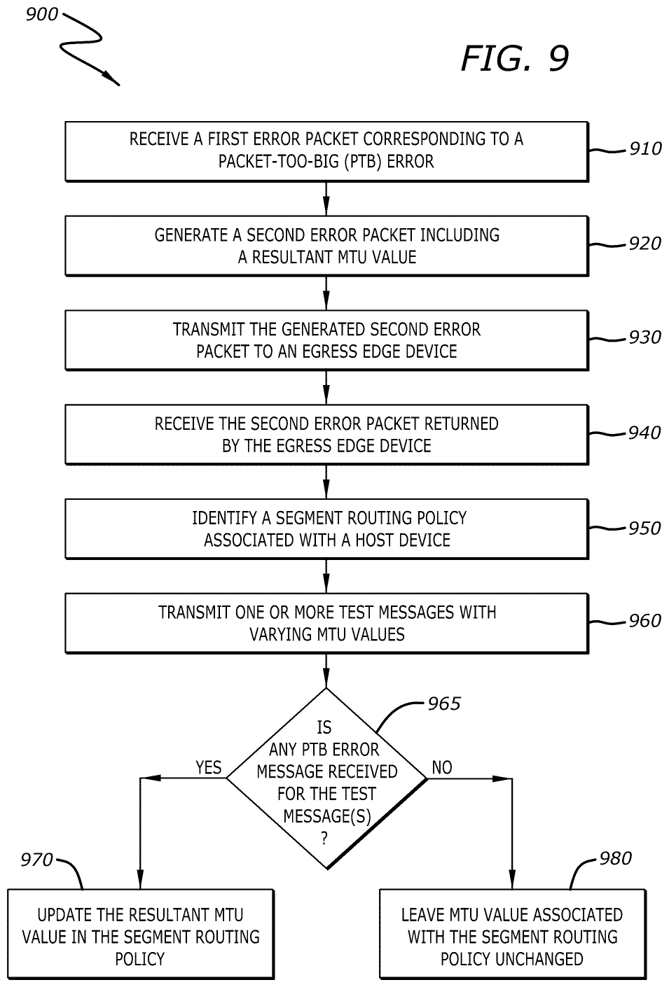

Referring to FIG. 9, a flowchart depicting a process 900 for identifying a segment routing policy associated with a host device and updating a resultant MTU value in the segment routing policy in accordance with various embodiments of the disclosure is shown. Consider an example scenario where a node such as an intermediate device located between an ingress edge device and an egress edge device, may fail to forward a packet encapsulated by the ingress edge device due to the size of the packet exceeding a link MTU of the intermediate device, and therefore, may generate and transmit a first error packet corresponding to a PTB error to the ingress edge device.

In many embodiments, the process 900 may receive the first error packet corresponding to the PTB error (block 910). In the above example scenario, the PTB error may occur at the intermediate device when a packet size is determined to be more than the MTU associated with the physical link between the intermediate device and the next intermediate device in a network path. The first error packet may include an initial MTU value and an underlay encapsulation. The initial MTU value may refer to the size (in bytes) of the largest packet that can pass along the network path of the segment routing domain between the host device and the destination device. The underlay encapsulation may introduce an additional overhead including added bytes to the first error packet.

In a number of embodiments, the process 900 may generate a second error packet including a resultant MTU value (block 920). In a variety of embodiments, the process 900 may generate the second error packet based on the received first error packet. In numerous embodiments, the process 900 may obtain the initial MTU value from the first error and then determine the resultant MTU value by decrementing a length of the underlay encapsulation from the initial MTU value.

In more embodiments, the process 900 may transmit the generated second error packet to the egress edge device (block 930). In additional embodiments, the process 900 may include a segment identifier of the egress edge device as a destination address in an outer header of the second error packet. The segment identifier may, for example, be a VPN-SID of the egress edge device. Based on the VPN-SID of the egress edge device included as the destination address in the outer header of the second error packet, the process 900 may transmit the second error packet to the egress edge device.

In further embodiments, the process 900 may receive the second error packet returned by the egress edge device (block 940). In still more embodiments, the egress edge device may include the VPN-SID of the ingress edge device in a new outer header of the second error packet and return the second error packet to the ingress edge device. In still further embodiments, the ingress edge device may receive the returned second error packet. In still additional embodiments, the VPN-SID of the ingress edge device may be associated with a VRF table corresponding to the IP address of the host device.

In some more embodiments, the process 900 may identify a segment routing policy associated with the host device (block 950). In further additional embodiments, the process 900 may identify the segment routing policy associated with the host device based on the segment identifier of the ingress edge device. In several embodiments, on receiving the second error packet returned by the egress edge device, the process 900 may perform a lookup, on the destination address included in an inner header of the second error packet, in the VRF table associated with the VPN-SID of the ingress edge device that is present in the outer header of the second error packet. Based on the lookup, the process 900 can identify the segment routing policy associated with the host device.

In yet more embodiments, the process 900 may transmit one or more test packets with varying MTU values (block 960). In many further embodiments, the process 900 may execute dynamic path MTU discovery using performance measurement, for example, Segment Routing-Performance Measurement (SR-PM). SR-PM may be utilized for detecting MTU sizes of segment routing policies. In these embodiments, the process 900 may utilize an SR-PM liveliness probe to validate the identified segment routing policy. In many further embodiments, the SR-PM liveliness probe may be extended and may keep track of MTU probing versus the segment routing policy. For executing the SR-PM liveliness probe, test packets are periodically transmitted through the network to verify whether the segment routing policies are active and operational. In these embodiments, the process 900 may transmit different test packets, herein referred to as “probes”, with different MTU values via the network path to validate the legitimacy of the first error packet.

In still yet further embodiments, the process 900 may determine whether any PTB error message is received for the test packet(s) (block 965). While executing the SR-PM liveliness probe, the process 900 may transmit different probes with different MTU values. If the same intermediate node that generated the first error packet fails to forward a probe due to the size of the probe exceeding the link MTU, the intermediate node may again generate and transmit a PTB error message, for example, an ICMP-PTB error message, to the ingress edge device. The process 900 may await this PTB error message corresponding to one of the probes with an associated MTU value, from the intermediate node.

In still yet additional embodiments, in response to determining the PTB error message is received for the test packet(s), the process 900 may update the resultant MTU value in the segment routing policy (block 970). In several additional embodiments, receiving the PTB error message for the test packet from the same intermediate node may indicate that the previously received first error packet is valid. As a result, the process 900 may update the MTU value of the identified segment routing policy with the resultant MTU value.

However, in numerous additional embodiments, in response to determining the PTB error message is not received for the test packet(s), the process 900 may leave the MTU value associated with the segment routing policy unchanged (block 980). In many additional embodiments, non-reception of the PTB error message for the test packet from the same intermediate node may indicate that the previously received first error packet may be invalid or a fraud message.

Although a specific embodiment for a process 900 for identifying a segment routing policy associated with a host device and updating a resultant MTU value in the segment routing policy suitable for carrying out the various steps, processes, methods, and operations described herein is discussed with respect to FIG. 9, any of a variety of systems and/or processes may be utilized in accordance with embodiments of the disclosure. For example, SR-PM liveliness probes can be utilized to probe the MTU size of the VPN-SID and keep track of pure VPN-SID only routes. The elements depicted in FIG. 9 may also be interchangeable with other elements of FIG. 1-8 and FIG. 10-11 as required to realize a particularly desired embodiment.

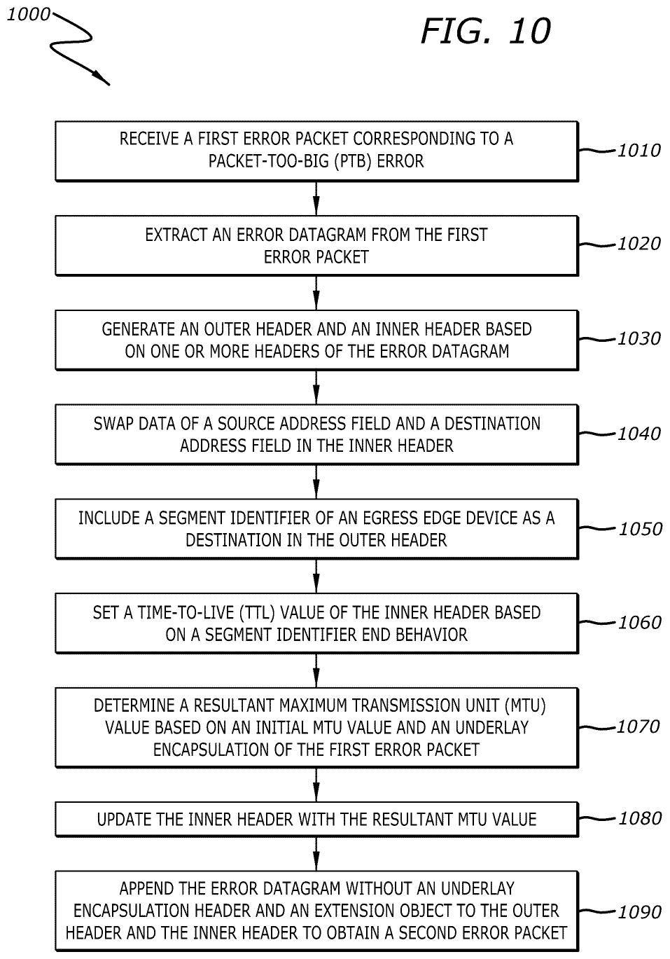

Referring to FIG. 10, a flowchart depicting a process 1000 for generating an error packet including a resultant MTU value in accordance with various embodiments of the disclosure is shown. Consider an example scenario where a node such as an intermediate device located between an ingress edge device and an egress edge device, may fail to forward a packet encapsulated by the ingress edge device due to the size of the packet exceeding a link MTU of the intermediate device. The intermediate device may generate and transmit a first error packet corresponding to a PTB error, for example, an ICMP-PTB error, to the ingress edge device. In this example scenario, the first error packet may correspond to an ICMPv6-PTB error and may be referred to as an ICMPv6-PTB error packet. The intermediate device may encapsulate incoming, encapsulated packet, for example, an IPv6 packet, inside the first error packet by adding, for example, an IPv6+ICMPv6-PTB header and embedding the original IPv6 packet inside a payload of the first error packet. In a variety of embodiments, the payload of the first error packet may be referred to as an “error datagram” of the first error packet. The intermediate device may transmit the first error packet to the ingress edge device.

In many embodiments, the process 1000 may receive the first error packet corresponding to the PTB error (block 1010). The first error packet may include an initial MTU value and an underlay encapsulation. The first MTU value may refer to the size (in bytes) of the largest packet that can pass along the network path of the segment routing domain between the host device and the destination device. The underlay encapsulation may introduce an additional overhead including added bytes to the first error packet.

In a number of embodiments, the process 1000 may extract the error datagram from the first error packet (block 1020). When the ingress edge device receives the first error packet from the intermediate device, the process 1000 may proceed to generate a second error packet. The process 1000 may examine the first error packet to identify a protocol used. In an example, the process 1000 may identify the protocol as ICMP by examining the first error packet. If the process 1000 identifies the protocol as ICMP, the process 1000 may check an ICMP type and code fields to determine the type of ICMP error associated with the first error packet. When the type of ICMP error is determined, the process 1000 may parse the first error packet to extract the error datagram. For example, in the ICMP, the error packet may encapsulate a portion of the original packet that caused the error. The process 1000 may extract this original packet to understand the context of the error.

In a variety of embodiments, the process 1000 may generate an outer header and an inner header based on one or more headers of the error datagram (block 1030). After extraction of the error datagram from the first error packet, the process 1000 may utilize the headers in the error datagram to generate the second error packet. In some embodiments, the process 1000 may generate the outer and inner headers for the second error packet using an outer header and an inner header of the error datagram of the first error packet including an extension. The generated outer header of the second error packet may be similar to the outer header of the error datagram of the first error packet.

In more embodiments, the process 1000 may swap data of a source address field and a destination address field in the inner header (block 1040). In more embodiments, to swap the data of the source address field and the destination address field in the inner header of the second error packet, the process 1000 may store the original source address in a temporary variable, replace the value in the source address field with the value from the destination address field, and replace the value in the destination address field with the value stored in the temporary variable. Swapping the data of the source address field and the destination address field in the inner header of the second error packet may ensure that the second error packet travels to the egress edge device and be forwarded back to the host device that is behind the ingress edge device. In an example, after swapping, the source address field contains the IP address of a destination device and the destination address field contains the IP address of the host device.

In additional embodiments, the process 1000 may include a segment identifier of the egress edge device as a destination in the outer header (block 1050). For example, the process 1000 may include the VPN-SID of the egress edge device as the destination in the destination address field of the outer header of the second error packet. When the ingress edge device receives the first error packet, the process 1000 may be unaware about the VRF table with which the IP address of the host device is associated. However, the outer header of the error datagram of the first error packet may contain the VPN-SID allocated to the egress edge device, which may be associated with the correct VRF table associated with the IP address of the host device. Accordingly, the process 1000 may include the VPN-SID of the egress edge device as the destination address in the outer header of the second error packet.

In further embodiments, the process 1000 may set a TTL value of the inner header based on a segment identifier END behavior (block 1060). In several embodiments, the process 1000 may determine and update a TTL value of the inner header of the second error packet based on the segment identifier END behavior associated with the second error packet. In an example scenario, the process 1000 may determine the end behavior of the VPN-SID of the egress edge device, that is indicated in the outer header of the second error packet. In still more embodiments, to identify a matching VPN-SID end behavior, the process 1000 may provide a BGP with the last SID in the SRH of the second error packet. The last SID in the SRH may represent the final destination of the second error packet or the last hop in the segment list before the second error packet reaches its final destination or undergoes its final processing.

In still further embodiments, the matching end behavior identified by the process 1000 may determine the appropriate TTL value that should be updated in the inner header of the second error packet. For example, if the VPN-SID behavior is END. DT, the process 1000 may set the TTL value to “2” in the inner header of the second error packet. In another example, if the VPN-SID behavior is END. DX, the process 1000 may set the TTL value to “4” in the inner header of the second error packet. In still additional embodiments, the process 1000 may configure the determined TTL value to expire at the ingress edge device upon receiving the second error packet returned by the egress edge device.

In some more embodiments, the process 1000 may determine a resultant MTU value based on an initial MTU value and an underlay encapsulation of the first error packet (block 1070). In certain embodiments, for determining the resultant MTU value, the process 1000 may decrement a length of the underlay encapsulation from the initial MTU value. Consider an example where the link MTU is 1500 bytes and the underlay encapsulation is 40 bytes. In this example, the resultant MTU value may be set to (1500−40)=1460 bytes instead of 1500 bytes. In yet more embodiments, the process 1000 may update the inner header with the resultant MTU value (block 1080). Based on the above example, the process 1000 may update the inner header with the resultant MTU value of 1460 bytes.

In still yet more embodiments, the process 1000 may append the error datagram, without an underlay encapsulation header, and an extension object to the outer header and the inner header to obtain the second error packet (block 1090). The process 1000 may remove the underlay encapsulation header from the error datagram and append the resultant error datagram and the extension object to the outer header and the inner header to obtain the second error packet. The second error packet, therefore, may include the outer header, the inner header, the appended error datagram without the underlay encapsulation header, and the extension object. The extension object may correspond to a Path MTU Discovery Indicator (PMTUD-I) configured to indicate that the second error packet may be intended for updating the MTU of a local segment routing policy/VPN-SID.

Although a specific embodiment for a process 1000 for generating an error packet including a resultant MTU value in accordance with various embodiments of the disclosure suitable for carrying out the various steps, processes, methods, and operations described herein is discussed with respect to FIG. 10, any of a variety of systems and/or processes may be utilized in accordance with embodiments of the disclosure. For example, a provider edge headend such as the ingress edge device that received the first error packet corresponding to an ICMP-PTB error can generate a non-ICMP error packet corresponding to a non-ICMP error that embeds the required information such as the VPN-SID of the egress edge device, the TTL values, and the resultant MTU value, following the header generation. The elements depicted in FIG. 10 may also be interchangeable with other elements of FIG. 1-9 and FIG. 11 as required to realize a particularly desired embodiment.

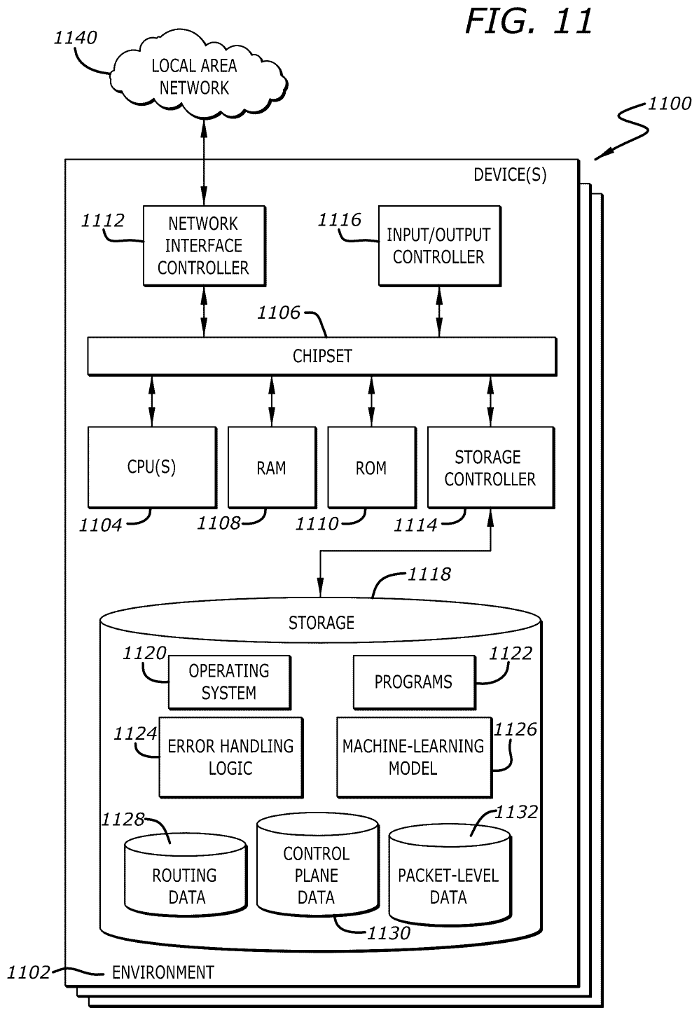

Referring to FIG. 11, a conceptual block diagram for one or more devices 1100 capable of executing components and logic for implementing the functionality and embodiments described above is shown. The embodiment of the conceptual block diagram depicted in FIG. 11 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device(s) 1100 may, in some examples, correspond to physical devices or to virtual resources described herein.

In many embodiments, the device(s) 1100 may include an environment 1102 such as a baseboard or a “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device(s) 1100. In more embodiments, one or more processors 1104, such as, but not limited to, central processing units (CPUs) can be configured to operate in conjunction with a chipset 1106. The processor(s) 1104 can be standard programmable CPUs that perform arithmetic and logical operations necessary for the operation of the device(s) 1100.

In additional embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1106 may provide an interface between the processor(s) 1104 and the remainder of the components and devices within the environment 1102. The chipset 1106 can provide an interface to a random-access memory (RAM) 1108, which can be used as the main memory in the device(s) 1100 in some embodiments. The chipset 1106 can further be configured to provide an interface to a computer-readable storage medium such as a read-only memory (ROM) 1110 or a non-volatile RAM (NVRAM) for storing basic routines that can help with various tasks such as, but not limited to, starting up the device(s) 1100 and/or transferring information between the various components and devices. The ROM 1110 or NVRAM can also store other application components necessary for the operation of the device(s) 1100 in accordance with various embodiments described herein.

Different embodiments of the device(s) 1100 can be configured to operate in a networked environment using logical connections to remote computing devices and computer systems through a network, such as the network 1140. The chipset 1106 can include functionality for providing network connectivity through a network interface controller (NIC) 1112, which may include a gigabit Ethernet adapter or similar component. The NIC 1112 can be capable of connecting the device(s) 1100 to other devices over the network 1140. It is contemplated that multiple NICs 1112 may be present in the device(s) 1100, connecting the device(s) 1100 to other types of networks and remote systems.

In further embodiments, the device(s) 1100 can be connected to a storage 1118 that provides non-volatile storage for data accessible by the device(s) 1100. The storage 1118 can, for example, store an operating system 1120, applications or programs 1122, routing data 1128, control plane data 1130, and packet-level data 1132, which are described in greater detail below. The storage 1118 can be connected to the environment 1102 through a storage controller 1114 connected to the chipset 1106. In certain embodiments, the storage 1118 can include one or more physical storage units. The storage controller 1114 can interface with the physical storage units through a serial attached SCSI (SAS) interface, a serial advanced technology attachment (SATA) interface, a fiber channel (FC) interface, or other type of interface for physically connecting and transferring data between computers and physical storage units.

The device(s) 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

For example, the device(s) 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device(s) 1100 can further read or access information from the storage 1118 by detecting the physical states or characteristics of one or more particular locations within the physical storage units.

In addition to the storage 1118 described above, the device(s) 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device(s) 1100. In some examples, the operations performed by a cloud computing network, and or any components included therein, may be supported by one or more devices similar to the device(s) 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (EPROM), electrically-erasable programmable ROM (EEPROM), flash memory or other solid-state memory technology, compact disc ROM (CDROM), digital versatile disk (DVD), high definition DVD (HD-DVD), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device(s) 1100. According to one embodiment, the operating system 1120 includes the LINUX operating system. According to another embodiment, the operating system 1120 includes the WINDOWS® SERVER operating system from MICROSOFT Corporation of Redmond, Washington. According to further embodiments, the operating system 1120 can include the UNIX operating system or one of its variants. It should be appreciated that other operating systems can also be utilized. The storage 1118 can store other system or application programs and data utilized by the device(s) 1100.

In various embodiment, the storage 1118 or other computer-readable storage media is encoded with computer-executable instructions which, when loaded into the device(s) 1100, may transform it from a general-purpose computing system into a special-purpose computer capable of implementing the embodiments described herein. These computer-executable instructions may be stored as applications or programs 1122 and transform the device(s) 1100 by specifying how the processor(s) 1104 can transition between states, as described above. In some embodiments, the device(s) 1100 has access to computer-readable storage media storing computer-executable instructions which, when executed by the device(s) 1100, perform the various processes described above with regard to FIG. 1-10. In more embodiments, the device(s) 1100 can also include computer-readable storage media having instructions stored thereupon for performing any of the other computer-implemented operations described herein.

In still further embodiments, the device(s) 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device(s) 1100 may not include all of the components shown in FIG. 11, and can include other components that are not explicitly shown in FIG. 11, or may utilize an architecture completely different than that shown in FIG. 11.

As described above, the device(s) 1100 may support a virtualization layer, such as one or more virtual resources executing on the device(s) 1100. In some examples, the virtualization layer may be supported by a hypervisor that provides one or more virtual machines running on the device(s) 1100 to perform functions described herein. The virtualization layer may generally support a virtual resource that performs at least a portion of the techniques described herein.

In many embodiments, the device(s) 1100 can include an error handling logic 1124 that may be responsible for relaying a PTB error packet received from SRv6 underlay nodes to a host device, with the underlay overhead updated to include a received MTU value. The error handling logic 1124 can be configured to perform various operations such as, but not limited to, receiving a first error packet corresponding to a PTB error and including a first MTU value and an underlay encapsulation, generating a second error packet based on the first error packet, determining a second MTU value based on the first MTU value and the underlay encapsulation, updating the second error packet with the second MTU value, and relaying the second error packet including the second MTU value to the host device via an egress edge device. In a variety of embodiments, the second error packet returned by the egress edge device may include a segment identifier of the device(s) 1100. In a number of embodiments, the error handling logic 1124 may also be responsible for correlating the received first error packet and identifying an affected local segment routing policy/segment identifier to update the MTU of the respective segment routing policy/segment identifier. The error handling logic 1124 may identify the affected segment routing policy associated with the host device based on the segment identifier of the device(s) 1100 included in the returned second error packet. Once the affected segment routing policy is identified, the error handling logic 1124 may update the second MTU value (also interchangeably referred to as the resultant MTU value) in the segment routing policy.

In a number of embodiments, the storage 1118 can include routing data 1128. The routing data 1128 may relate to data representative of the nodes along a network path in a segment routing domain. For example, the routing data 1128 may include information of the segment routing policies associated with the nodes in the segment routing domain. In a variety of embodiments, the routing data 1128 may include routing tables of the nodes. For example, the routing data 1128 may include the VRF tables corresponding to segment identifiers. The error handling logic 1124 may be configured to utilize the routing data 1128 for relaying the second error packet including the second MTU value to the host device via the egress edge device and for updating the affected local segment routing policy/segment identifier with the second MTU value.

In various embodiments, the storage 1118 can further include control plane data 1130. The control plane data 1130 may refer to packet information with extensions used for determining whether an error packet should be punted to the control plane. The control plane data 1130 can include, but is not limited to, topology information, device configurations such as IP addresses, routing policies, interface settings, or the like; ICMP-PTB error message information; routing protocol information such as routing updates, routing protocols, or the like.

In still more embodiments, the storage 1118 can further include packet-level data 1132. The packet-level data 1132 may relate to packet size, header information, payload information, encapsulation information, or the like. For example, the packet-level data 1132 may include source address information, destination address information, TTL values, MTU values, checksum information, or the like associated with transmitted packets.

Finally, in many embodiments, data may be processed into a format usable by a machine-learning (“ML”) model 1126 (e.g., feature vectors), and or other pre-processing techniques. The ML model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models. The ML model 1126 may be configured to analyze the routing data 1128, the control plane data 1130, and the packet-level data 1132 to perform ICMP-PTB error handling and dynamic path MTU discovery using performance measurement. In numerous embodiments, the ML model 1126 may be utilized to identify one or more segment routing policies for MTU update based on context information associated with received ICMP-PTB messages. Context information can be learnt by correlating segment routing policies with one or more attributes of historical ICMP-PTB messages.

Although a specific embodiment for a device 1100 suitable for configuration with the error handling logic 1124 suitable for carrying out the various steps, processes, methods, and operations described herein is discussed with respect to FIG. 11, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the error handling logic 1124 acts in tandem between the devices. The elements depicted in FIG. 11 may also be interchangeable with other elements of FIG. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
a network interface controller configured to provide access to a network; and
a memory communicatively coupled to the processor, wherein the memory comprises an error handling logic that is configured to:
receive a first error packet comprising a first maximum transmission unit (MTU) value and an underlay encapsulation;
generate a second error packet based on the first error packet;
determine a second MTU value based on the first MTU value and the underlay encapsulation;
update the second error packet with the second MTU value; and
relay the second error packet including the second MTU value to a host device via an egress edge device.

2. The network device of claim 1, wherein the network device is configured as an ingress edge device communicatively coupled to the host device and to the egress edge device via one or more intermediate devices.

3. The network device of claim 1, wherein the error handling logic is further configured to determine that the first error packet corresponding to a Packet-Too-Big (PTB) error is received in a segment routing domain of the network, and wherein the second error packet is relayed to the host device via the egress edge device in response to determining that the first error packet is received in the segment routing domain.

4. The network device of claim 1, wherein the second error packet comprises an inner header including a source address field and a destination address field, and an outer header including a source address field and a destination address field.

5. The network device of claim 4, wherein the error handling logic is further configured to set a time-to-live (TTL) value of each of the inner header and the outer header of the second error packet to a default TTL value.

6. The network device of claim 4, wherein, to relay the second error packet to the host device via the egress edge device, the error handling logic is further configured to:
swap data of the source address field and the destination address field in the inner header of the second error packet; and
include a segment identifier of the egress edge device as a destination in the destination address field of the outer header of the second error packet.

7. The network device of claim 6, wherein the segment identifier is a Virtual Private Network-Segment Identifier.

8. The network device of claim 6, wherein, to relay the second error packet to the host device via the egress edge device, the error handling logic is further configured to:
transmit, to the egress edge device, the second error packet including the segment identifier of the egress edge device;
receive, from the egress edge device, the second error packet in which the outer header is replaced by another outer header including a segment identifier of the network device;
remove the another outer header from the second error packet; and
transmit the second error packet to the host device.

9. The network device of claim 8, wherein the segment identifier of the network device is associated with a Virtual Routing and Forwarding (VRF) table corresponding to an address of the host device.

10. The network device of claim 9, wherein the error handling logic is further configured to transmit the second error packet to the host device based on the VRF table associated with the segment identifier of the network device.

11. The network device of claim 1, wherein determining the second MTU value comprises decrementing a length of the underlay encapsulation from the first MTU value.

12. A network device, comprising:
a processor;
a network interface controller configured to provide access to a network; and
a memory communicatively coupled to the processor, wherein the memory comprises an error handling logic that is configured to:
receive a first error packet corresponding to a Packet-Too-Big (PTB) error;
generate a second error packet based on the first error packet, wherein the second error packet comprises a resultant maximum transmission unit (MTU) value;
transmit the generated second error packet to an egress edge device;
receive the second error packet, including a segment identifier of the network device, returned by the egress edge device;
identify, based on the segment identifier of the network device, a segment routing policy associated with a host device; and
update the resultant MTU value in the segment routing policy.

13. The network device of claim 12, wherein the generated second error packet further comprises an extension object configured to indicate a requirement for a segment routing policy update for the resultant MTU value.

14. The network device of claim 13, wherein the error handling logic is further configured to identify the segment routing policy associated with the host device and update the resultant MTU value in the segment routing policy, in response to the received second error packet including the extension object.

15. The network device of claim 12, wherein the first error packet comprises an initial MTU value and an underlay encapsulation, and wherein the error handling logic is further configured to determine the resultant MTU value by decrementing a length of the underlay encapsulation from the initial MTU value.

16. The network device of claim 12, wherein the second error packet further comprises an outer header, and wherein prior to transmitting the generated second error packet to the egress edge device, the error handling logic is further configured to set a time-to-live (TTL) value of the outer header to a default TTL value.

17. The network device of claim 12, wherein the second error packet further comprises an inner header, and wherein prior to transmitting the generated second error packet to the egress edge device, the error handling logic is further configured to determine and update a time-to-live (TTL) value of the inner header of the generated second error packet based on a segment identifier END behavior associated with the second error packet.

18. The network device of claim 17, wherein the determined TTL value is configured to expire at the network device upon receiving the second error packet returned by the egress edge device.

19. The network device of claim 12, wherein the second error packet further comprises an inner header including a destination address, and wherein to identify the segment routing policy associated with the host device, the error handling logic is further configured to:
identify a Virtual Routing and Forwarding (VRF) table associated with the segment identifier of the network device; and
perform a lookup on the destination address in the identified VRF table, wherein the segment routing policy is identified as a result of the lookup.

20. A method, comprising:
receiving a first error packet comprising a first maximum transmission unit (MTU) value and an underlay encapsulation;
generating a second error packet based on the first error packet;
determining a second MTU value based on the first MTU value and the underlay encapsulation;
updating the second error packet with the second MTU value; and
relaying the second error packet including the second MTU value to a host device via an egress edge device.
